(19) United States
(12) Patent Application Publication
(10) Pub. No.: US 2026/0342777 A1
(43) Pub. Date: Oct. 29, 2026

(54) PRIVACY-PRESERVING FEDERATED LEARNING USING ENCRYPTED SEMANTIC TENSOR AGGREGATION

(71) Applicant: Leptude, Inc., Austin, TX (US)

(72) Inventor: John A. Fortkort, Austin, TX (US)

(21) Appl. No.: 19/660,196

(22) Filed: Apr. 27, 2026

Related U.S. Application Data
(60) Provisional application No. 63/795,210, filed on Apr. 25, 2025.

(51) Int. Cl. H04L 9/40; G06F 21/60; G06N 3/098; H04L 9/00

(52) U.S. Cl. CPC H04L 63/0428; G06F 21/602; G06N 3/098; H04L 9/008

(57) ABSTRACT

Systems and methods are provided for privacy-preserving federated learning in which multiple edge devices collaboratively train a machine-learning model without sharing raw data or full model parameters. Each device generates a semantic tensor, such as a routing-coefficient tensor or other intermediate representation, and encrypts the tensor using a homomorphic-encryption scheme supporting ciphertext-space addition and scalar multiplication. Encrypted tensors are transmitted to an aggregation system that performs aggregation operations without decryption to produce an encrypted aggregate tensor. The aggregate tensor is returned to the devices for local model updates. A noise-monitoring mechanism tracks ciphertext noise growth and dynamically routes computations to a secure execution environment when a threshold is exceeded, enabling decryption, aggregation, and re-encryption under protected conditions. The approach reduces bandwidth usage, preserves semantic structure, and maintains confidentiality across distributed learning environments while supporting scalable and efficient model convergence.

### CROSS-REFERENCE TO RELATED APPLICATIONS

This application claims the benefit of U.S. provisional application number 63/795,210 filed Apr. 25, 2025, entitled “RETRIEVAL AUGMENTED LATENT FUSION GAN WITH CAPSULE BASED SEMANTIC ROUTING” and having the same inventor, and which is incorporated herein by reference in its entirety.

### FIELD OF THE DISCLOSURE

The present disclosure relates generally to computer-implemented systems and hardware architectures for distributed machine learning. More particularly, the disclosure pertains to systems and methods for privacy-preserving federated learning in which intermediate semantic representations generated by machine-learning models are selectively extracted, encrypted, and aggregated across multiple devices. The disclosure further relates to cryptographic processing techniques, including homomorphic encryption and hybrid secure computation, as well as hardware-accelerated architectures, secure execution environments, and control mechanisms for managing encrypted computation under resource and noise constraints.

### BACKGROUND OF THE DISCLOSURE

Recent advances in distributed machine learning have led to the development of federated learning frameworks in which multiple devices collaboratively train shared models while retaining data locally. In such frameworks, individual nodes perform local training on private datasets and periodically transmit model updates to a central aggregation system. Techniques such as federated averaging enable the aggregation of model parameters or gradients across participating nodes, allowing convergence toward a global model without requiring centralized data collection. These approaches are widely implemented in mobile, healthcare, and enterprise environments where data privacy and locality constraints are significant considerations.

Parallel developments in cryptographic computation have produced methods for performing arithmetic operations on encrypted data. Homomorphic encryption schemes, including leveled and fully homomorphic variants, support operations such as addition and multiplication directly in the ciphertext domain. Implementations based on lattice cryptography, such as Brakerski-Fan-Vercauteren and Cheon-Kim-Kim-Song schemes, enable practical evaluation of linear and polynomial functions on encrypted inputs. These techniques have been applied to privacy-preserving data processing, secure analytics, and encrypted inference, often in conjunction with optimized libraries and hardware acceleration.

Secure multi-party computation protocols provide an alternative approach to privacy-preserving computation by distributing data across multiple parties in the form of secret shares. In these systems, computation is performed collaboratively using cryptographic protocols that prevent any individual party from reconstructing the underlying data. Methods based on additive secret sharing and precomputed multiplication triples have been widely studied and deployed in distributed settings. These protocols are commonly used in environments where trust assumptions are limited and coordination among multiple parties is feasible.

Neural network architectures have evolved to incorporate structured representations that capture relationships among features or entities within data. Capsule networks introduce mechanisms for modeling hierarchical relationships through the use of vector-valued units and routing procedures that determine assignment probabilities between layers. Other architectures, such as attention-based models and transformer networks, generate intermediate representations in the form of attention matrices or embedding tensors that encode contextual relationships among input elements. These intermediate representations are often used to guide model behavior and improve performance across a variety of tasks.

Hardware acceleration has become an integral component of modern machine learning systems. Graphics processing units, tensor processing units, and application-specific integrated circuits are commonly employed to execute large-scale matrix operations and neural network computations. These accelerators often support reduced-precision arithmetic formats, such as INT8 or lower, to improve throughput and energy efficiency. In parallel, cryptographic accelerators have been developed to support modular arithmetic operations required by encryption schemes, including large-integer multiplication and polynomial evaluation.

Secure execution technologies provide mechanisms for isolating sensitive computations within protected environments. Trusted execution environments, implemented in hardware, allow code and data to be executed in isolation from the rest of the system, with protections against unauthorized access or tampering. Examples include enclave-based architectures that provide secure memory regions and attestation capabilities, enabling verification of code integrity and confidentiality during execution. These technologies are commonly used in applications requiring strong security guarantees, including key management, secure data processing, and confidential computing.

Networked systems for distributed computation often employ hierarchical architectures to manage communication and aggregation across large numbers of devices. In such systems, intermediate nodes may perform partial aggregation or preprocessing before forwarding data to higher-level servers. This approach reduces communication overhead and improves scalability in geographically distributed deployments. Synchronization mechanisms are used to coordinate computation across nodes, with both synchronous and asynchronous models being employed depending on application requirements.

Software frameworks and communication protocols support the coordination of distributed machine learning tasks. Remote procedure call mechanisms, message passing interfaces, and secure transport protocols enable data exchange among nodes and servers. These systems often incorporate mechanisms for monitoring performance metrics, such as latency and bandwidth utilization, to manage resource allocation and system behavior. Configuration and policy management tools allow administrators to define operational parameters and adapt system behavior to changing conditions.

Together, these developments in distributed learning, cryptographic computation, neural network design, hardware acceleration, secure execution, and networked systems form the foundation of current approaches to privacy-preserving machine learning and distributed data processing.

### BRIEF DESCRIPTION OF THE DRAWINGS

The accompanying drawings illustrate exemplary embodiments of the systems and methodologies disclosed herein and, together with the description, serve to explain the principles of the invention.

FIG. 1 is a schematic diagram of a federated capsule-based learning system with encrypted routing aggregation, showing a plurality of edge nodes communicating with an aggregation server over a network.

FIG. 2 is a block diagram of a noise-aware control loop for secure aggregation routing, illustrating dynamic selection between homomorphic processing and secure enclave execution based on a ciphertext-noise metric.

FIG. 3 is a block diagram of a capsule-routing accelerator configured to generate routing-coefficient tensors from intermediate model representations.

FIG. 4 is a block diagram of a linear homomorphic-encryption datapath, illustrating ciphertext addition and plaintext-scalar multiplication operations with restricted arithmetic functionality.

FIG. 5 is a block diagram of a streaming secure-enclave aggregation system, illustrating segmented processing of encrypted tensors within a bounded memory trusted execution environment.

FIG. 6 is a block diagram of a generalized semantic tensor aggregation framework, illustrating extraction, encryption, aggregation, and reintegration of intermediate semantic tensors.

FIG. 7 is a block diagram of a policy-driven execution switching architecture, illustrating dynamic selection of computational pathways based on system metrics and policy evaluation.

FIG. 8 is a block diagram of a hybrid cryptographic aggregation engine, illustrating dual-mode operation using homomorphic encryption and multi-party computation.

FIG. 9 is a block diagram of a hierarchical aggregation architecture, illustrating multi-level aggregation across edge nodes, regional aggregators, and a root aggregation server.

FIG. 10 is a block diagram of an integrated system-on-chip architecture, illustrating combined machine-learning acceleration, cryptographic processing, and secure execution within a single device.

### SUMMARY OF THE DISCLOSURE

In one aspect, a system and method are provided for privacy-preserving federated machine learning in which a plurality of distributed devices collaboratively train or refine a model without exchanging raw data or full model parameters. Each participating device executes a machine-learning model to generate an intermediate semantic tensor representing structured relationships within locally processed data. The semantic tensor is transformed into a representation compatible with a homomorphic-encryption scheme and encrypted prior to transmission to an aggregation system. The aggregation system performs arithmetic operations directly on encrypted tensors to produce an encrypted aggregate tensor, which is returned to the participating devices for use in subsequent model updates.

In another aspect, preferred embodiments incorporate a control mechanism that monitors a characteristic of encrypted data, such as noise growth associated with homomorphic operations, and dynamically selects among multiple computation pathways. When a predetermined condition is detected, encrypted data may be routed to a protected execution environment in which decryption, aggregation, and re-encryption are performed within a secure boundary. This adaptive control enables continued operation across multiple aggregation cycles while maintaining computational integrity.

In a further aspect, preferred embodiments support multiple cryptographic aggregation modes within a unified framework. Homomorphic aggregation may be employed for asynchronous or partially available data, while alternative secure computation techniques may be selected when system conditions permit coordinated interaction. A policy-driven selection mechanism may be used to determine the appropriate aggregation mode based on system metrics, network conditions, or operational constraints.

In another aspect, preferred embodiments include specialized processing components configured to generate and handle semantic tensors efficiently. Such components may comprise hardware accelerators for model execution and intermediate representation extraction, enabling high-throughput processing of data while preparing outputs for encrypted aggregation. The resulting architecture aligns the structure of intermediate model representations with the operational constraints of cryptographic processing.

In still another aspect, preferred embodiments provide hierarchical aggregation capabilities in which intermediate aggregation nodes combine encrypted tensors prior to transmission to higher-level coordination systems. This arrangement reduces communication overhead and supports scalable deployment across geographically distributed environments while maintaining confidentiality at each stage of aggregation.

In a further aspect, preferred embodiments may integrate machine-learning processing, cryptographic computation, and secure execution capabilities within a unified hardware platform. Such integration reduces latency, improves energy efficiency, and enhances security by confining sensitive operations within protected environments. The disclosed systems, devices and methodologies thereby support efficient, scalable, and privacy-preserving distributed learning across a wide range of deployment scenarios.

### DETAILED DESCRIPTION

### Definitions

As used herein, the following terms shall have the meanings set forth below. These definitions are intended to clarify the terms used in the claims and specification, and are not intended to limit the scope of the invention beyond what is explicitly claimed.

Semantic tensor: a data structure representing intermediate model information that encodes relationships, features, or contextual associations derived from input data. A semantic tensor may include routing-coefficient tensors, attention matrices, feature maps, embedding vectors, or other intermediate representations generated within a machine-learning model. A semantic tensor may be stored in memory and represented as a multi-dimensional array of numerical values processed by a processor or accelerator.

Routing-coefficient tensor: a semantic tensor produced by a capsule-based neural network that encodes assignment probabilities or agreement measures between lower-level and higher-level capsules. Routing-coefficient tensors may represent part-to-whole relationships and are typically normalized to form probability distributions.

Capsule-based neural network: a machine-learning architecture comprising groups of units referred to as capsules, each capsule representing a structured entity or feature. Capsule-based neural networks may include routing mechanisms that determine relationships among capsules based on agreement or similarity.

Homomorphic encryption: a cryptographic technique that enables one or more arithmetic operations to be performed directly on encrypted data without requiring decryption. Homomorphic encryption schemes may support a restricted set of operations, including addition and/or scalar multiplication, without requiring support for arbitrary computation.

Leveled homomorphic encryption: a form of homomorphic encryption that supports a limited number of operations on ciphertexts before decryption becomes unreliable due to noise accumulation. Leveled schemes are typically configured for specific computational depths.

Ciphertext noise: a measure of accumulated error or distortion within encrypted data resulting from successive homomorphic operations. Ciphertext noise may be quantified using one or more metrics including modulus-switching depth, error variance, or other scheme-specific parameters.

Encrypted tensor: a tensor represented in ciphertext form under a cryptographic scheme such that its underlying plaintext values are not directly accessible without decryption.

Secure execution environment: a hardware- or software-based protected execution context that isolates code and data from unauthorized access. Such environments may include hardware-isolated memory regions and execution contexts that prevent access by other processes or system components.

Trusted execution environment: a secure execution environment implemented using hardware-based isolation mechanisms that protect data confidentiality and integrity during execution. Examples include Intel SGX, AMD SEV-SNP, and Arm Confidential Compute Architecture.

Aggregation: a process by which multiple data elements, such as tensors or model updates, are combined to produce a single representative result. Aggregation may include operations such as summation, averaging, or weighted combination and may be performed in encrypted form, in secret-shared form, or in plaintext within a secure execution environment.

Aggregation round: a processing cycle in which multiple tensors are collected, combined, and redistributed among participating devices.

Federated learning: a distributed machine-learning paradigm in which multiple devices collaboratively train or refine a shared model while retaining local data and transmitting only derived information or model updates.

Intermediate representation: data generated within a machine-learning model during processing of input data, typically at an internal layer of the model. Intermediate representations may capture features, patterns, or relationships relevant to the task being performed.

Quantization: a process of converting numerical data from a higher-precision representation, such as floating-point, to a lower-precision representation, such as fixed-point or integer format, often to improve computational efficiency or compatibility with specific processing systems.

Multi-party computation: a cryptographic technique that enables multiple parties to jointly compute a function over their inputs while keeping those inputs private. Multi-party computation may involve secret sharing and coordinated communication among participants.

Secret sharing: a method for distributing a piece of data into multiple shares such that the original data can only be reconstructed when a sufficient number of shares are combined.

Policy engine: a component that evaluates system conditions and applies predefined or dynamically determined rules to control system behavior, including selection among multiple processing pathways.

Execution pathway: a processing route within a system through which data flows during computation. Different execution pathways may correspond to different processing modes, such as encrypted computation or secure enclave processing.

Execution mode: a selectable computational configuration in which a system performs processing using a specified method, including homomorphic processing, secure execution, or multi-party computation.

Hierarchical aggregation: a multi-level aggregation approach in which data is combined at intermediate nodes before being further aggregated at higher levels, thereby reducing communication overhead and improving scalability.

Accelerator: a hardware component configured to perform specialized computations more efficiently than a general-purpose processor, including but not limited to tensor operations or cryptographic arithmetic.

System-on-chip (SoC): an integrated circuit that combines multiple functional components, such as processing units, memory, and interfaces, on a single semiconductor device.

Interconnect fabric: a communication infrastructure within a hardware system that enables data transfer among components, which may be implemented as a network-on-chip or other high-speed interconnection mechanism.

Noise-monitoring module: a component configured to track characteristics of encrypted data, such as ciphertext noise, and provide signals that influence system behavior based on those characteristics.

Semantic aggregation: the process of combining semantic tensors or intermediate representations from multiple sources to produce a unified representation that captures shared structure or relationships across those sources.

Despite significant progress in distributed machine learning, existing federated learning frameworks remain constrained by the granularity and volume of information exchanged among participating nodes. Many approaches rely on transmitting full model parameters or gradient updates, which can result in substantial communication overhead, particularly for large-scale models. As model complexity increases, the size of these updates grows correspondingly, placing pressure on network bandwidth and limiting the practicality of federated deployments in resource-constrained environments. Additionally, frequent transmission of large model updates can introduce latency and synchronization challenges that hinder efficient convergence.

Privacy concerns also persist in existing systems, even when raw data is not directly shared. Model updates and gradients may contain latent information about the underlying training data, and various forms of inference attacks can exploit these signals to reconstruct sensitive inputs or identify characteristics of the data distribution. While techniques such as secure aggregation and differential privacy have been proposed, they often introduce trade-offs in terms of accuracy, computational cost, or system complexity. As a result, maintaining strong privacy guarantees while preserving model performance remains a challenging objective.

The use of cryptographic techniques to protect data during computation introduces additional limitations. Homomorphic encryption schemes, while enabling operations on encrypted data, are subject to constraints related to computational overhead and noise accumulation. Each arithmetic operation performed on ciphertexts increases the noise level, and excessive noise can render the encrypted data undecipherable. This limitation restricts the depth and complexity of computations that can be performed without resorting to costly procedures such as bootstrapping or re-encryption. Consequently, integrating homomorphic encryption into iterative machine learning workflows presents practical challenges.

Secure multi-party computation approaches face their own set of constraints, particularly with respect to communication requirements and synchronization. Many MPC protocols require multiple rounds of interaction among participating parties, leading to increased latency and sensitivity to network conditions. These protocols may also depend on assumptions regarding participant availability and non-collusion, which can be difficult to guarantee in dynamic or large-scale environments. The overhead associated with coordination and communication can limit the scalability of MPC-based systems.

Neural network architectures that produce structured intermediate representations, such as capsule networks or attention-based models, introduce additional complexity when incorporated into distributed or privacy-preserving settings. These architectures often rely on iterative or nonlinear operations that are not easily compatible with the constraints of encrypted computation. As a result, integrating such models into secure aggregation frameworks may require simplifications or approximations that reduce their effectiveness.

Hardware acceleration, while improving computational performance, does not fully address the challenges associated with secure and distributed computation. General-purpose accelerators are typically optimized for standard numerical operations and may not efficiently support the specialized arithmetic required by cryptographic schemes. Furthermore, the separation between machine learning accelerators and cryptographic processing units can lead to inefficiencies in data movement and system integration.

Secure execution environments provide a mechanism for protecting sensitive computations, but their use introduces limitations related to memory capacity, performance overhead, and deployment complexity. Trusted execution environments often have restricted memory regions, making it difficult to process large datasets or model parameters entirely within the protected domain. Additionally, transitioning data between secure and non-secure contexts can incur overhead and complicate system design.

Scalability challenges arise in distributed systems that span large numbers of devices or geographic regions. Coordinating aggregation across many nodes can result in increased communication latency and susceptibility to partial failures. Hierarchical aggregation architectures can mitigate some of these issues, but they introduce additional layers of complexity and require careful management of data consistency and synchronization.

Overall, existing approaches to distributed and privacy-preserving machine learning must contend with a combination of communication constraints, privacy risks, cryptographic limitations, architectural incompatibilities, and system-level inefficiencies. These challenges highlight the need for improved techniques that can reconcile the competing demands of performance, scalability, and security in modern machine learning systems.

Preferred embodiments of the systems, devices and methodologies disclosed herein provide a distributed learning architecture in which collaborating nodes exchange encrypted intermediate semantic representations rather than raw data or full model parameters. By selecting and transmitting semantically meaningful tensors generated within a model, such as routing-coefficient tensors or other structured intermediate representations, the amount of information exchanged between nodes is reduced while preserving the information most relevant to model convergence. This approach enables efficient coordination among participating devices while mitigating communication overhead associated with large parameter updates.

In preferred embodiments, semantic tensors are transformed into representations compatible with homomorphic encryption and processed using cryptographic schemes that permit arithmetic operations on encrypted data. Because aggregation is performed directly in the encrypted domain, sensitive information is not exposed to aggregation systems or intermediary infrastructure. This design reduces the risk of information leakage associated with conventional parameter or gradient sharing and allows distributed learning to be conducted under stricter privacy constraints without requiring centralized access to underlying datasets.

It has now been found that some or all of the foregoing problems may be addressed by preferred embodiments of the systems, devices and methodologies disclosed herein.

Preferred embodiments further incorporate mechanisms for managing the operational limitations of encrypted computation. In particular, a noise-monitoring capability evaluates the integrity of encrypted data as successive operations are performed, enabling the system to maintain reliable computation over multiple aggregation cycles. When predetermined conditions are detected, computation may be selectively redirected to a protected execution environment where decryption and re-encryption can be performed securely. This dynamic control of execution pathways allows continued operation without degradation of cryptographic correctness, thereby extending the practical applicability of encrypted aggregation techniques.

The architecture described herein supports multiple cryptographic processing modes within a unified framework. In certain embodiments, homomorphic aggregation is used when asynchronous participation or partial data availability is expected, while alternative secure computation techniques may be employed under conditions that favor coordinated interaction. The ability to adaptively select among aggregation strategies allows the system to maintain efficiency across a wide range of network conditions and deployment scenarios, improving robustness in distributed environments.

Preferred embodiments also provide specialized processing components for generating and handling semantic tensors. By utilizing dedicated acceleration structures for model execution and intermediate representation extraction, the system efficiently produces the data required for encrypted aggregation without incurring unnecessary computational overhead. The resulting tensors are structured in a manner that aligns with the constraints of cryptographic processing, enabling aggregation operations that are both efficient and compatible with privacy-preserving requirements.

In some embodiments, aggregation is performed across multiple hierarchical levels, allowing intermediate results to be combined locally before being propagated to higher-level coordination nodes. This arrangement reduces the volume of data transmitted over long-distance network links and improves scalability for deployments involving large numbers of devices. At the same time, the use of encrypted representations ensures that confidentiality is preserved at every stage of the aggregation process.

Preferred embodiments may further integrate machine learning acceleration, cryptographic processing, and secure execution capabilities within a unified hardware platform. By minimizing data movement between components and performing sensitive operations within protected environments, such implementations achieve reduced latency and improved energy efficiency. This integration facilitates deployment in edge computing environments where resource constraints and security requirements are particularly stringent.

Through these combined features, the systems, devices and methodologies disclosed herein enable distributed learning processes that maintain strong privacy guarantees while improving communication efficiency, computational reliability, and scalability. The use of encrypted semantic representations, dynamic execution control, and adaptable aggregation strategies provides a framework that supports effective model convergence across diverse and distributed data sources without exposing sensitive information.

The systems, devices and methodologies disclosed herein may be further understood with reference to the following particular, non-limiting embodiments.

### Embodiment 1: Federated Capsule-Based Learning System With Encrypted Routing Aggregation

This embodiment demonstrates a distributed machine-learning architecture in which multiple independent computational nodes collaboratively train or refine a shared semantic model without exchanging raw data or full model parameters. The embodiment illustrates how capsule-based representations, which encode structured semantic relationships, can be selectively extracted, encrypted, and aggregated in a manner that preserves both privacy and bandwidth efficiency. The system highlights a practical solution to the competing constraints of distributed learning, cryptographic computation limits, and real-time model synchronization.

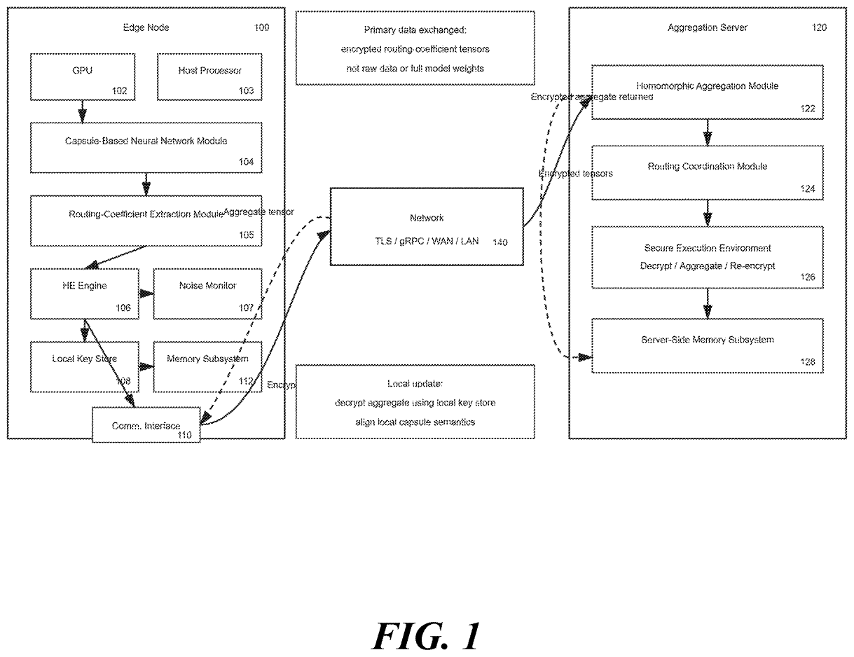

Referring to FIG. 1, a federated learning system is implemented comprising a plurality of edge nodes 100 that are communicatively coupled to an aggregation server 120 via a network 140. Each edge node 100 includes a graphics-processing unit (GPU) 102, a host processor 103, a capsule-based neural network module 104, a routing-coefficient extraction module 105, a homomorphic-encryption engine 106, a noise-monitoring module 107, a local key store 108, a communication interface 110, and a local memory subsystem 112. The aggregation server 120 includes a homomorphic aggregation module 122, a routing coordination module 124, a secure execution environment 126, and a server-side memory subsystem 128.

During operation, each edge node 100 processes locally stored data residing in the local memory subsystem 112 using the capsule-based neural network module 104, which executes on the GPU 102 under control of the host processor 103. The capsule-based neural network module 104 may include multiple layers of convolutional or transformer-based feature extraction followed by a capsule-routing stage that computes relationships among semantic entities represented as capsules. The routing-coefficient extraction module 105 captures the output of the capsule-routing stage in the form of a routing-coefficient tensor that encodes assignment probabilities or agreement weights between lower-level and higher-level capsules.

The routing-coefficient tensor is provided to the homomorphic-encryption engine 106, which first converts the tensor into a fixed-point numerical representation compatible with a selected encryption scheme. The homomorphic-encryption engine 106 then encrypts the quantized tensor using a leveled homomorphic-encryption scheme that supports ciphertext-space addition and plaintext-scalar multiplication. The resulting ciphertext is stored temporarily in the local memory subsystem 112 and subsequently transmitted via the communication interface 110 over the network 140 to the aggregation server 120.

The noise-monitoring module 107 operates in parallel with the homomorphic-encryption engine 106 and tracks the growth of ciphertext noise associated with successive encryption and aggregation operations. The noise-monitoring module 107 may compute metrics such as modulus-switching depth, noise variance, or other indicators of cryptographic degradation. These metrics are used locally to determine whether encrypted data can continue to be processed using homomorphic operations or whether an alternative processing pathway is required.

At the aggregation server 120, encrypted routing-coefficient tensors received from multiple edge nodes 100 are stored in the server-side memory subsystem 128 and processed by the homomorphic aggregation module 122. The homomorphic aggregation module 122 performs ciphertext-space addition across tensors from different nodes and applies a scaling factor to compute an average or otherwise aggregated representation. Because the operations are performed entirely in the encrypted domain, the aggregation server 120 does not access any plaintext data or model parameters.

The routing coordination module 124 manages synchronization across edge nodes 100, ensuring that aggregation rounds proceed in a coordinated manner and that aggregated results are distributed back to participating nodes. The routing coordination module 124 may also track participation status, enforce timing constraints, and coordinate fallback behavior when certain nodes fail to provide updates.

When the noise-monitoring module 107 at one or more edge nodes 100 or at the aggregation server 120 determines that ciphertext noise has reached a threshold beyond which further homomorphic processing would be unreliable, the routing coordination module 124 directs encrypted tensors into the secure execution environment 126. The secure execution environment 126 comprises a trusted execution environment implemented using hardware-based isolation technologies. Within this environment, encrypted tensors are decrypted using protected keys, aggregated in plaintext using conventional arithmetic operations, and re-encrypted under fresh cryptographic parameters. The resulting ciphertext is returned to the homomorphic aggregation module 122 or directly to the edge nodes 100, thereby restoring the system to a low-noise operational state.

Each edge node 100 receives the encrypted aggregate routing-coefficient tensor via the communication interface 110 and stores it in the local memory subsystem 112. The tensor is decrypted using keys stored in the local key store 108, which may be protected by hardware security modules or trusted platform modules. The decrypted aggregate tensor is then provided to the capsule-based neural network module 104, where it is used to update model parameters or to impose a consistency constraint during subsequent training iterations. In particular, the aggregate routing-coefficient tensor may be used as a target distribution in a loss function that encourages alignment between local and global capsule semantics.

The interaction among the GPU 102, the capsule-based neural network module 104, the routing-coefficient extraction module 105, and the homomorphic-encryption engine 106 forms a pipeline in which semantically meaningful intermediate representations are selectively externalized and protected prior to transmission. The inclusion of the noise-monitoring module 107 and the secure execution environment 126 ensures that the system remains robust despite the inherent limitations of homomorphic encryption, particularly with respect to noise accumulation.

The embodiment may be implemented using a combination of hardware and software resources. The GPU 102 may be a high-performance accelerator such as an NVIDIA A100 or equivalent device capable of executing tensor operations at scale. The homomorphic-encryption engine 106 may be implemented using optimized cryptographic libraries such as Microsoft SEAL or equivalent frameworks, potentially accelerated by dedicated hardware. The secure execution environment 126 may be implemented using technologies such as Intel SGX, AMD SEV-SNP, or Arm Confidential Compute Architecture. The communication interface 110 may utilize secure transport protocols such as TLS over gRPC, and the network 140 may include both local-area and wide-area networking infrastructure.

This embodiment demonstrates that by isolating and aggregating routing-coefficient tensors rather than full model weights, the system achieves a reduction in communication bandwidth while preserving the semantic integrity of the learned model. At the same time, the use of encryption and secure fallback mechanisms ensures that sensitive information is not exposed during the aggregation process, thereby enabling practical deployment of federated learning systems in environments subject to strict privacy constraints.

### Embodiment 2: Noise-Aware Control Loop for Secure Aggregation Routing

This embodiment demonstrates a hardware-assisted control architecture that dynamically manages encrypted computation pathways based on real-time measurements of cryptographic noise. The embodiment illustrates how a feedback-driven control loop enables sustained operation of homomorphic encryption across multiple aggregation rounds by selectively diverting computations to a secure execution environment when noise levels approach critical limits. This approach ensures both computational correctness and efficient utilization of cryptographic resources in distributed learning systems.

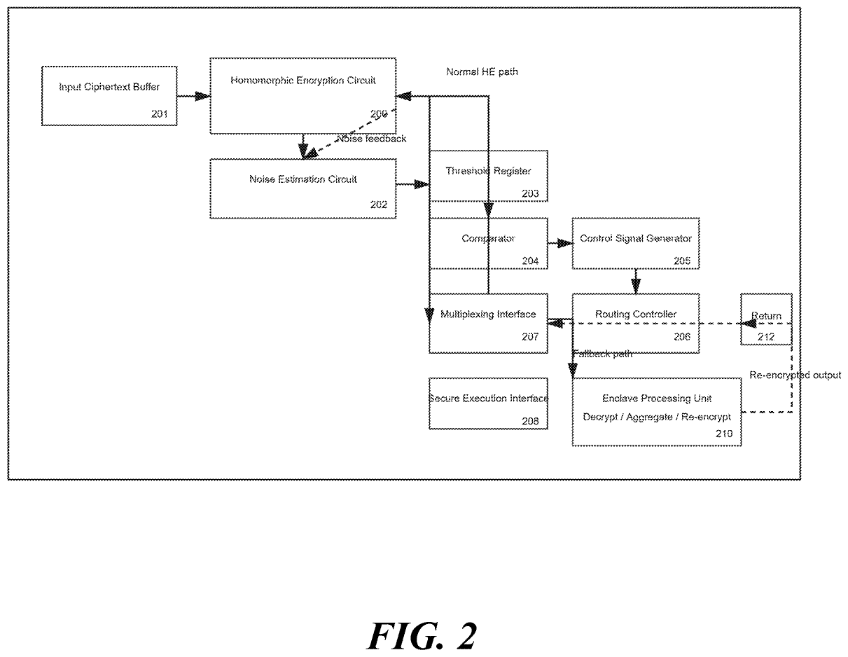

Referring to FIG. 2, a noise-aware control system is implemented comprising a homomorphic-encryption circuit 200, an input ciphertext buffer 201, a noise-estimation circuit 202, a threshold register 203, a threshold comparator 204, a control signal generator 205, a routing controller 206, a multiplexing interface 207, a secure-execution interface 208, an enclave processing unit 210, and a return path interface 212. These components collectively form a closed-loop control system that monitors and regulates encrypted computation flow.

During operation, encrypted routing-coefficient tensors are received and stored in the input ciphertext buffer 201, from which they are supplied to the homomorphic-encryption circuit 200. The homomorphic-encryption circuit 200 performs permitted arithmetic operations on ciphertexts, including addition and scalar multiplication, in accordance with the constraints of the underlying homomorphic-encryption scheme. Each operation contributes incrementally to ciphertext noise, which must be carefully managed to prevent loss of decryption fidelity.

The noise-estimation circuit 202 is coupled to the homomorphic-encryption circuit 200 and continuously monitors internal state variables associated with ciphertext processing. These variables may include modulus-switching depth, accumulated noise variance, ciphertext scaling factors, or other indicators of noise growth. The noise-estimation circuit 202 may be implemented using hardware counters, arithmetic units, or embedded monitoring logic that tracks operation counts and associated noise contributions in real time.

The output of the noise-estimation circuit 202 is compared against a predefined threshold stored in the threshold register 203. The threshold comparator 204 evaluates whether the measured noise exceeds the allowable limit and generates a corresponding control signal. This control signal is passed to the control signal generator 205, which formats the signal into a routing directive for downstream components.

The routing controller 206 receives the routing directive and determines the appropriate processing path for subsequent ciphertext operations. Under normal conditions, when noise levels remain below the threshold, the routing controller 206 directs ciphertexts to continue through the homomorphic-encryption circuit 200 via the multiplexing interface 207. This path enables efficient, fully encrypted aggregation without requiring decryption.

When the threshold comparator 204 indicates that the noise level has exceeded the permissible limit, the routing controller 206 redirects ciphertexts through the secure-execution interface 208. The secure-execution interface 208 provides a protected communication channel to the enclave processing unit 210, which is implemented as a trusted execution environment with hardware-enforced isolation.

Within the enclave processing unit 210, encrypted tensors are decrypted using keys that are inaccessible to external components. The decrypted tensors are then aggregated using conventional arithmetic operations, producing a plaintext aggregate result. This result is subsequently re-encrypted under a refreshed set of cryptographic parameters, thereby resetting the noise budget associated with the ciphertext. The re-encrypted aggregate is transmitted back to the main processing pipeline via the return path interface 212, where it re-enters the homomorphic-encryption circuit 200 for further processing.

The multiplexing interface 207 plays a critical role in enabling seamless switching between the homomorphic processing path and the secure execution path. It may be implemented as a hardware multiplexer controlled by signals from the routing controller 206, ensuring that data flow is redirected without interruption or loss of synchronization. The routing controller 206 may itself be implemented as a finite-state machine or programmable control unit capable of responding to dynamic system conditions.

The closed-loop interaction among the homomorphic-encryption circuit 200, the noise-estimation circuit 202, the threshold comparator 204, and the routing controller 206 ensures that the system operates within safe cryptographic limits while maximizing the use of efficient homomorphic operations. By automatically invoking the enclave processing pathway only when necessary, the system minimizes the performance overhead associated with secure enclave execution while preserving correctness and security.

The embodiment may be implemented using a combination of hardware and software resources. The homomorphic-encryption circuit 200 may be realized using FPGA-based arithmetic units or ASIC designs optimized for modular arithmetic. The noise-estimation circuit 202 may utilize dedicated hardware counters and arithmetic logic units, while the threshold comparator 204 may be implemented as a simple digital comparator. The enclave processing unit 210 may be implemented using technologies such as Intel SGX, AMD SEV-SNP, or Arm Confidential Compute Architecture, with the secure-execution interface 208 providing encrypted data transfer via PCIe or similar interconnects.

The input ciphertext buffer 201 and return path interface 212 may reside in system memory accessible to both trusted and untrusted components, with appropriate protections in place to prevent leakage of sensitive data. The control signal generator 205 and routing controller 206 may be implemented in firmware or hardware, depending on system requirements for latency and flexibility.

This embodiment demonstrates that by integrating real-time noise monitoring with dynamic execution control, the system can extend the practical depth of homomorphic encryption in federated learning applications. The architecture ensures that encrypted computations remain within operational bounds while providing a seamless fallback mechanism that preserves both privacy and computational integrity.

### Embodiment 3: Capsule-Routing Accelerator for Semantic Tensor Generation

This embodiment demonstrates a specialized hardware acceleration architecture for executing capsule-routing operations that generate structured semantic tensors suitable for privacy-preserving aggregation. The embodiment illustrates how routing-coefficient tensors can be produced efficiently at scale using a dedicated processing pipeline, thereby enabling real-time or near-real-time integration with encrypted aggregation workflows. The architecture highlights how semantic structure can be preserved and externalized in a controlled manner without exposing underlying raw data or full model parameters.

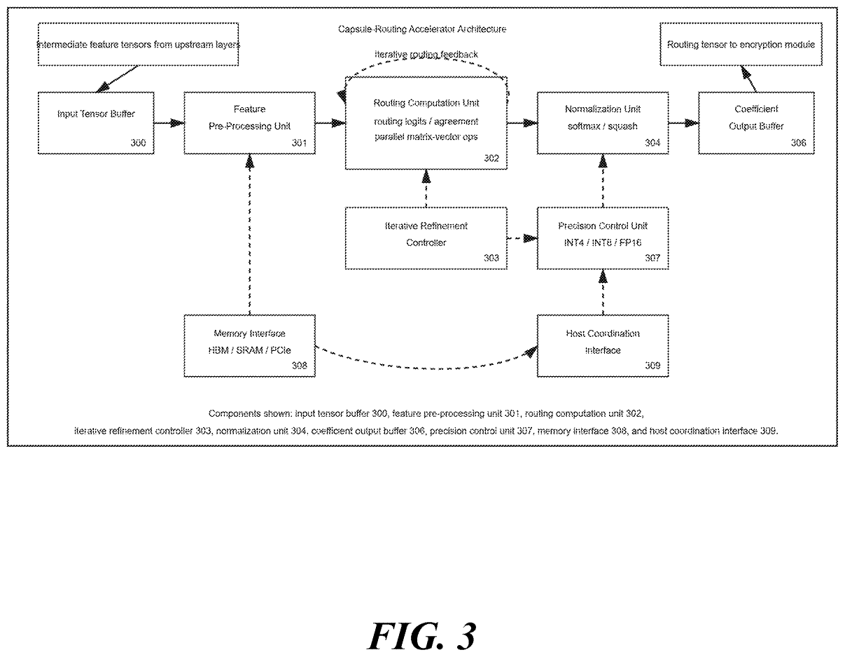

Referring to FIG. 3, a capsule-routing accelerator is implemented comprising an input tensor buffer 300, a feature pre-processing unit 301, a routing computation unit 302, an iterative refinement controller 303, a normalization unit 304, a coefficient output buffer 306, a precision control unit 307, a memory interface 308, and a host coordination interface 309. These components collectively form a high-throughput pipeline for generating routing-coefficient tensors from intermediate neural network representations.

During operation, feature representations generated by upstream layers of a neural network are received into the input tensor buffer 300, which may reside in on-chip SRAM or high-bandwidth memory. The feature pre-processing unit 301 performs transformations such as dimensional alignment, scaling, or projection to ensure compatibility with the routing computation unit 302. These transformations may include matrix multiplication, convolutional projection, or linear embedding operations, depending on the structure of the input data.

The routing computation unit 302 performs the core capsule-routing operations, computing assignment probabilities between lower-level and higher-level capsules. This computation may involve iterative agreement mechanisms in which candidate routing weights are refined based on similarity metrics between capsule outputs. The routing computation unit 302 may include parallel matrix multiplication engines, vector processing units, and accumulation registers configured to compute routing logits and intermediate coefficients.

The iterative refinement controller 303 governs the number of routing iterations and manages the feedback loop within the routing computation unit 302. In each iteration, intermediate routing coefficients are updated based on agreement measures, and the controller 303 ensures convergence by controlling iteration count, convergence thresholds, or early termination conditions. The controller 303 may be implemented as a hardware state machine or microcoded control unit.

Outputs from the routing computation unit 302 are passed to the normalization unit 304, which applies normalization functions to produce valid probability distributions. The normalization unit 304 may implement softmax operations, squashing functions, or other nonlinear transformations that constrain routing coefficients within a defined range. The normalization process ensures that the resulting routing-coefficient tensor represents meaningful assignment probabilities suitable for downstream aggregation.

The normalized routing-coefficient tensor is stored in the coefficient output buffer 306, which serves as a staging area for subsequent processing by encryption components. The precision control unit 307 may adjust the numerical precision of the routing-coefficient tensor prior to output, converting high-precision floating-point values into reduced-precision representations such as INT8 or INT4 formats. This conversion reduces memory footprint and improves compatibility with downstream homomorphic-encryption modules.

The memory interface 308 manages data movement between the accelerator and external memory systems, including transfers to host memory or direct interfaces with encryption hardware. The host coordination interface 309 enables communication between the accelerator and a host processor, allowing configuration of routing parameters, monitoring of execution status, and synchronization with other system components.

The interaction among the input tensor buffer 300, the routing computation unit 302, the iterative refinement controller 303, and the normalization unit 304 forms a tightly coupled pipeline that produces routing-coefficient tensors in a deterministic and efficient manner. The inclusion of the precision control unit 307 ensures that the output tensor can be readily consumed by cryptographic modules without requiring additional preprocessing.

The embodiment may be implemented using GPU tensor cores, FPGA-based matrix engines, or custom ASIC designs optimized for parallel computation. The routing computation unit 302 may leverage hardware acceleration for matrix multiplication and vector operations, while the normalization unit 304 may utilize lookup tables or specialized arithmetic units for efficient nonlinear computation. The iterative refinement controller 303 may be implemented using programmable control logic, enabling flexibility in routing algorithms.

The input tensor buffer 300 and coefficient output buffer 306 may be implemented using high-bandwidth memory resources, such as HBM or on-chip SRAM, to support high-throughput data movement. The memory interface 308 may utilize PCIe, NVLink, or similar interconnects to transfer data between the accelerator and other system components.

This embodiment demonstrates that by isolating capsule-routing operations within a dedicated accelerator, the system can generate semantically meaningful routing-coefficient tensors at high speed and with controlled precision. The resulting tensors are well-suited for encryption and aggregation, enabling seamless integration into privacy-preserving federated learning systems while maintaining the structural advantages of capsule-based representations.

### Embodiment 4: Linear Homomorphic Encryption Datapath for Routing-Coefficient Aggregation

This embodiment demonstrates a specialized cryptographic datapath configured to perform only linear operations on encrypted semantic tensors, thereby enabling efficient and scalable aggregation under homomorphic encryption constraints. The embodiment illustrates how restricting the supported operation set to ciphertext addition and plaintext-scalar multiplication reduces noise accumulation, simplifies hardware implementation, and aligns the cryptographic pipeline with the mathematical structure of routing-coefficient aggregation. This design enables repeated aggregation cycles without requiring expensive bootstrapping or full homomorphic generality.

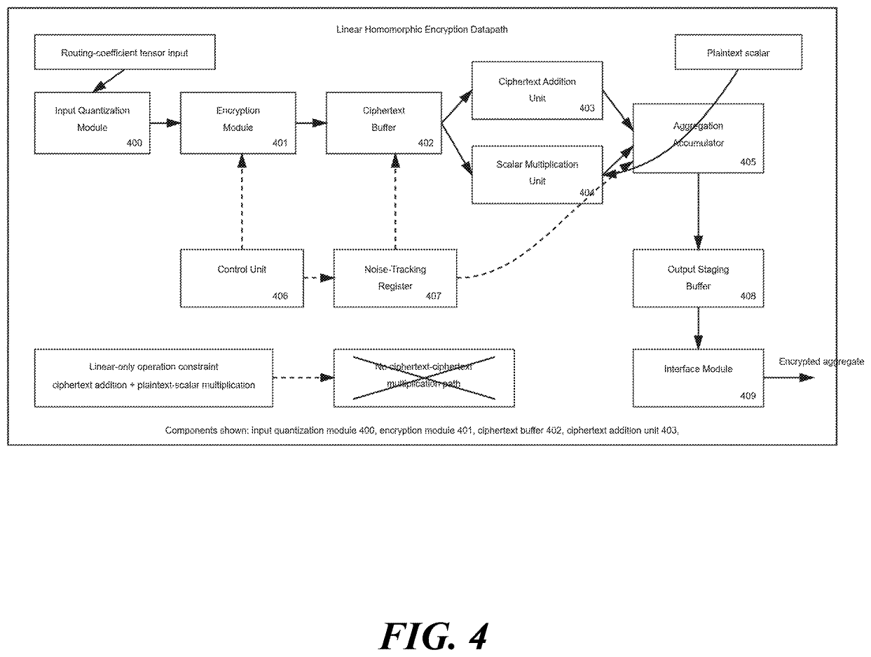

Referring to FIG. 4, a linear homomorphic encryption datapath is implemented comprising an input quantization module 400, an encryption module 401, a ciphertext buffer 402, a ciphertext addition unit 403, a scalar multiplication unit 404, an aggregation accumulator 405, a control unit 406, a noise-tracking register 407, an output staging buffer 408, and an interface module 409. These components collectively form a constrained arithmetic pipeline that operates entirely within the linear subset of a homomorphic-encryption scheme.

During operation, routing-coefficient tensors generated by upstream components are first provided to the input quantization module 400, which converts floating-point values into fixed-point representations compatible with the selected homomorphic-encryption scheme. The quantization process may include scaling by a predetermined factor, rounding to integer values, and clipping to a supported numerical range. The quantized tensor is then passed to the encryption module 401, which encodes the data into ciphertext form using a leveled homomorphic-encryption scheme such as RNS-BFV or CKKS.

The resulting ciphertext is stored in the ciphertext buffer 402, which provides temporary storage and alignment for subsequent operations. The ciphertext addition unit 403 performs element-wise addition of ciphertexts received from multiple sources, such as different edge nodes in a federated system. The addition operation is implemented using modular arithmetic circuits that operate on encrypted polynomial representations, preserving the homomorphic property without requiring decryption.

The scalar multiplication unit 404 applies a plaintext scaling factor to ciphertexts, enabling operations such as averaging or weighted aggregation. The scaling factor may be represented as a plaintext constant encoded within the encryption scheme, and the multiplication is performed using optimized modular arithmetic circuits. The scalar multiplication unit 404 does not perform ciphertext-ciphertext multiplication, thereby avoiding the significant noise growth associated with such operations.

Outputs from the ciphertext addition unit 403 and the scalar multiplication unit 404 are accumulated in the aggregation accumulator 405, which maintains intermediate aggregation results across multiple inputs. The aggregation accumulator 405 may be implemented as a register array or memory structure capable of storing encrypted tensor values and updating them incrementally as new ciphertexts are processed.

The control unit 406 orchestrates the sequence of operations within the datapath, ensuring that only permitted operations—namely ciphertext addition and plaintext-scalar multiplication—are executed. The control unit 406 may enforce operation constraints by disabling or omitting hardware pathways for unsupported operations, such as ciphertext-ciphertext multiplication. This restriction may be implemented structurally, for example by excluding multiplier circuits capable of handling two ciphertext operands, thereby ensuring that the datapath is inherently limited to linear operations.

The noise-tracking register 407 maintains metadata associated with ciphertext processing, including the number of operations performed and estimated noise growth. This information may be used by external control systems, such as the noise-aware control loop described in Embodiment 2, to determine when alternative processing pathways should be invoked.

Processed ciphertexts are transferred to the output staging buffer 408, which prepares the data for transmission or further processing. The interface module 409 provides connectivity to external components, such as communication interfaces or secure execution environments, enabling the datapath to participate in larger system workflows.

The interaction among the encryption module 401, the ciphertext addition unit 403, the scalar multiplication unit 404, and the aggregation accumulator 405 forms a streamlined pipeline optimized for the specific requirements of routing-coefficient aggregation. By limiting operations to the linear subset supported by leveled homomorphic encryption, the datapath minimizes computational overhead and extends the number of aggregation rounds that can be performed before noise levels become prohibitive.

The embodiment may be implemented using FPGA-based modular arithmetic units, ASIC designs optimized for polynomial arithmetic, or specialized cryptographic accelerators. The encryption module 401 may leverage hardware implementations of BFV or CKKS schemes, while the ciphertext addition unit 403 and scalar multiplication unit 404 may be implemented using parallel modular adders and multipliers. The control unit 406 may be realized as a finite-state machine or microcontroller, and the noise-tracking register 407 may be implemented using dedicated hardware counters.

The ciphertext buffer 402 and output staging buffer 408 may utilize on-chip SRAM or external memory resources, depending on throughput requirements. The interface module 409 may support high-speed data transfer protocols such as PCIe, enabling integration with GPU-based processing pipelines or network interfaces.

This embodiment demonstrates that by architecturally constraining the homomorphic-encryption datapath to linear operations aligned with the structure of routing-coefficient aggregation, the system achieves a balance between computational efficiency and cryptographic robustness. The design avoids unnecessary complexity while enabling scalable, privacy-preserving aggregation in distributed machine-learning environments.

### Embodiment 5: Streaming Secure-Enclave Aggregation With Bounded Memory Footprint

This embodiment demonstrates a secure aggregation mechanism that operates within a constrained trusted execution environment by processing encrypted tensors in a streaming manner. The embodiment illustrates how large encrypted semantic tensors can be safely decrypted, aggregated, and re-encrypted without exceeding enclave memory limitations, thereby enabling practical deployment of privacy-preserving aggregation in systems with restricted secure memory resources. The approach highlights a balance between cryptographic security, memory efficiency, and system scalability.

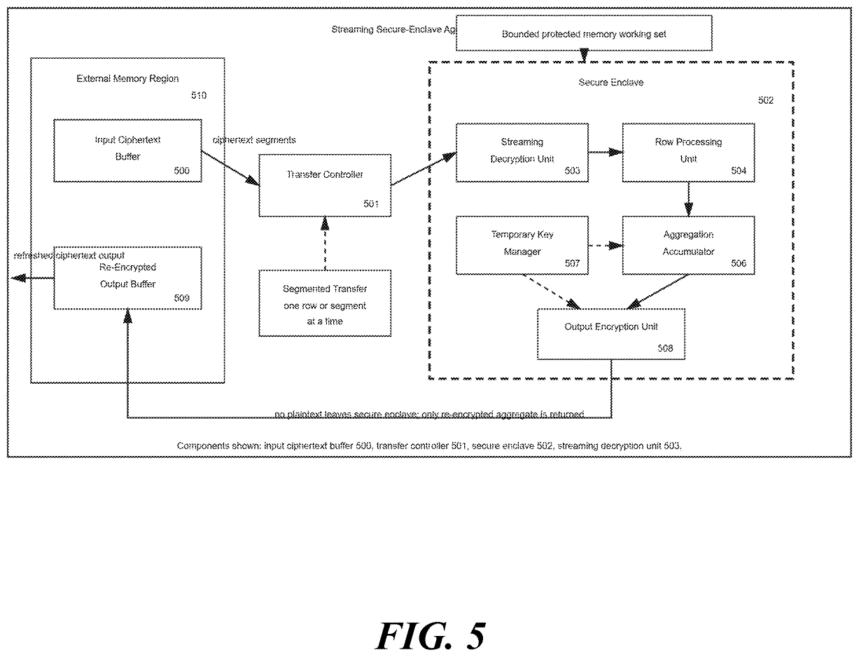

Referring to FIG. 5, a streaming secure-enclave aggregation system is implemented comprising an input ciphertext buffer 500, a transfer controller 501, a secure enclave 502, a streaming decryption unit 503, a row processing unit 504, an aggregation accumulator 506, a temporary key manager 507, an output encryption unit 508, a return interface 509, and an external memory region 510. These components collectively enable segmented processing of encrypted routing-coefficient tensors within a protected execution environment.

During operation, encrypted routing-coefficient tensors are received from external components and stored in the input ciphertext buffer 500, which resides in the external memory region 510 accessible to non-enclave system components. The transfer controller 501 manages the controlled movement of ciphertext data into the secure enclave 502, ensuring that only a limited portion of the data is transferred at any given time to comply with enclave memory constraints.

Within the secure enclave 502, the streaming decryption unit 503 receives ciphertext segments from the transfer controller 501 and decrypts them using cryptographic keys that are protected within the enclave. The decrypted data is immediately passed to the row processing unit 504, which operates on one row or segment of the routing-coefficient tensor at a time. This streaming approach ensures that only a small working set of data resides within the enclave memory at any moment.

The row processing unit 504 performs aggregation operations on the decrypted data, combining it with partial results stored in the aggregation accumulator 506. The aggregation accumulator 506 maintains intermediate results across multiple segments, enabling the system to compute a complete aggregate tensor incrementally. The accumulator may be implemented using registers or protected memory structures within the enclave, ensuring that intermediate plaintext values remain secure.

Once all segments of the input tensor have been processed, the aggregation accumulator 506 contains the final aggregated result in plaintext form. This result is passed to the output encryption unit 508, which re-encrypts the data using cryptographic parameters managed by the temporary key manager 507. The temporary key manager 507 may generate fresh encryption keys for each aggregation cycle, ensuring that the resulting ciphertext has a reset noise profile and enhanced security properties.

The re-encrypted aggregate tensor is transmitted out of the secure enclave 502 via the return interface 509, which places the ciphertext back into the external memory region 510 or forwards it to downstream components. The return interface 509 ensures that no plaintext data leaves the enclave, preserving the confidentiality of the aggregated tensor.

The transfer controller 501 and return interface 509 work in coordination to manage data flow between trusted and untrusted memory regions, using secure communication protocols and access controls to prevent unauthorized access. The secure enclave 502 enforces hardware-level isolation, ensuring that all sensitive operations, including decryption and aggregation, are performed within a protected environment.

The interaction among the streaming decryption unit 503, the row processing unit 504, and the aggregation accumulator 506 forms a pipeline that processes data incrementally, minimizing memory usage while maintaining computational correctness. The use of the temporary key manager 507 and output encryption unit 508 ensures that the aggregated result is securely re-encapsulated for further processing or transmission.

The embodiment may be implemented using secure enclave technologies such as Intel SGX, which provide a limited enclave page cache for protected memory. The input ciphertext buffer 500 and external memory region 510 may reside in standard system memory, while the secure enclave 502 operates within a restricted memory region. The streaming decryption unit 503 and row processing unit 504 may be implemented as lightweight arithmetic kernels within the enclave, optimized for low memory usage and high throughput.

The transfer controller 501 may be implemented as a DMA engine or software-controlled data mover that transfers data between memory regions in fixed-size segments. The aggregation accumulator 506 may utilize optimized data structures to support incremental updates, and the output encryption unit 508 may leverage hardware-accelerated cryptographic operations to minimize latency.

This embodiment demonstrates that by adopting a streaming approach to secure enclave processing, the system can perform aggregation of large encrypted tensors without requiring large amounts of protected memory. The design ensures that sensitive data is never exposed outside the enclave while enabling efficient aggregation and noise budget reset for homomorphic encryption workflows. This approach is particularly advantageous in cloud or edge environments where secure memory resources are limited but strong privacy guarantees are required.

### Embodiment 6: Generalized Semantic Tensor Aggregation Framework

This embodiment demonstrates a generalized aggregation architecture in which intermediate semantic tensors—rather than raw data or full model weights—are selectively extracted from machine-learning models, encrypted, and aggregated across distributed nodes. The embodiment illustrates how the inventive framework extends beyond capsule-routing coefficients to encompass a broader class of semantically meaningful internal representations, including attention matrices, latent feature maps, and embedding tensors. By abstracting the aggregation target to semantic tensors, the system enables flexible integration with diverse model architectures while preserving privacy and communication efficiency.

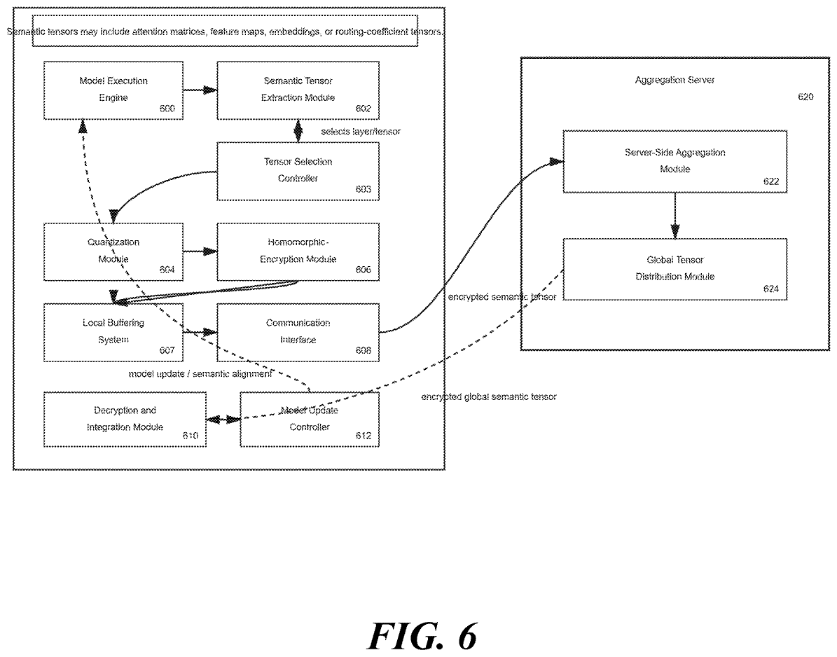

Referring to FIG. 6, a generalized semantic aggregation system is implemented comprising a model execution engine 600, a semantic tensor extraction module 602, a tensor selection controller 603, a quantization module 604, a homomorphic-encryption module 606, a local buffering system 607, a communication interface 608, an aggregation server 620, a server-side aggregation module 622, a global tensor distribution module 624, a decryption and integration module 610, and a model update controller 612. These components collectively enable extraction, protection, aggregation, and reintegration of semantic tensors within a distributed learning system.

During operation, the model execution engine 600 executes a machine-learning model using local data stored in memory resources associated with the edge device. The model may comprise a transformer architecture, a convolutional neural network, a capsule-based network, or a hybrid model incorporating multiple representation layers. As the model processes input data, intermediate representations are generated at various stages within the network.

The semantic tensor extraction module 602 is coupled to the model execution engine 600 and is configured to intercept and extract one or more intermediate tensors that encode semantic information. These tensors may include attention weight matrices from transformer layers, feature activation maps from convolutional layers, embedding vectors from latent spaces, or routing-coefficient tensors from capsule layers. The tensor selection controller 603 determines which tensors are extracted based on predefined criteria, such as layer type, semantic relevance, or privacy sensitivity.

The selected semantic tensor is passed to the quantization module 604, which converts the tensor into a fixed-point representation suitable for homomorphic encryption. The quantization process may include scaling, rounding, and clipping operations to ensure compatibility with the numerical constraints of the encryption scheme. The quantized tensor is then forwarded to the homomorphic-encryption module 606, which encrypts the tensor using a leveled homomorphic-encryption scheme.

The encrypted tensor is temporarily stored in the local buffering system 607, which may be implemented using system memory or dedicated buffer storage. The communication interface 608 transmits the encrypted tensor over a network to the aggregation server 620, which may be located in a cloud or data center environment.

At the aggregation server 620, encrypted tensors from multiple edge devices are received and stored in a server-side buffer associated with the server-side aggregation module 622. The server-side aggregation module 622 performs homomorphic aggregation operations, such as ciphertext addition and scaling, to produce an encrypted global semantic tensor that represents the combined information from participating devices.

The aggregated encrypted tensor is passed to the global tensor distribution module 624, which distributes the tensor back to the edge devices via the communication interface 608. Upon receipt, the encrypted tensor is processed by the decryption and integration module 610, which decrypts the tensor using locally stored cryptographic keys and prepares it for reintegration into the model execution engine 600.

The model update controller 612 governs how the decrypted global semantic tensor is incorporated into the model. This incorporation may involve updating model parameters, adjusting internal representations, or applying the tensor as a target or constraint within a loss function. For example, an attention matrix may be aligned with the global tensor to enforce consistency across distributed models, or a latent embedding may be adjusted to reflect global semantic structure.

The interaction among the semantic tensor extraction module 602, the homomorphic-encryption module 606, the server-side aggregation module 622, and the decryption and integration module 610 forms a closed-loop system in which semantic information is shared and refined without exposing raw data. The tensor selection controller 603 ensures that only appropriate tensors are extracted, while the model update controller 612 ensures that the aggregated information is applied effectively within the model.

The embodiment may be implemented using GPU-based execution for the model execution engine 600, with software hooks or hardware instrumentation enabling extraction of intermediate tensors. The homomorphic-encryption module 606 may utilize cryptographic libraries such as Microsoft SEAL, and the aggregation server 620 may be implemented on cloud infrastructure with sufficient computational resources to perform homomorphic operations.

The quantization module 604 and decryption and integration module 610 may be implemented in software or hardware depending on system requirements, while the communication interface 608 may utilize secure networking protocols such as TLS over gRPC. The local buffering system 607 and server-side aggregation module 622 may rely on high-speed memory resources to support efficient data movement.

This embodiment demonstrates that by generalizing the aggregation target from specific routing coefficients to a broader class of semantic tensors, the system achieves a flexible and extensible framework for privacy-preserving distributed learning. The approach enables integration with diverse model architectures while maintaining the core advantages of encrypted aggregation, including reduced bandwidth usage and protection of sensitive information.

### Embodiment 7: Policy-Driven Execution Switching Architecture

This embodiment demonstrates a dynamic control architecture that governs the selection of computational pathways in a privacy-preserving distributed learning system based on a multi-factor evaluation of system conditions. The embodiment illustrates how encrypted computation can be adaptively routed between homomorphic processing and secure execution environments using a policy-driven decision framework. This approach extends beyond simple noise-based triggers to incorporate performance, reliability, and trust considerations, thereby enabling robust and efficient operation in heterogeneous and variable deployment environments.

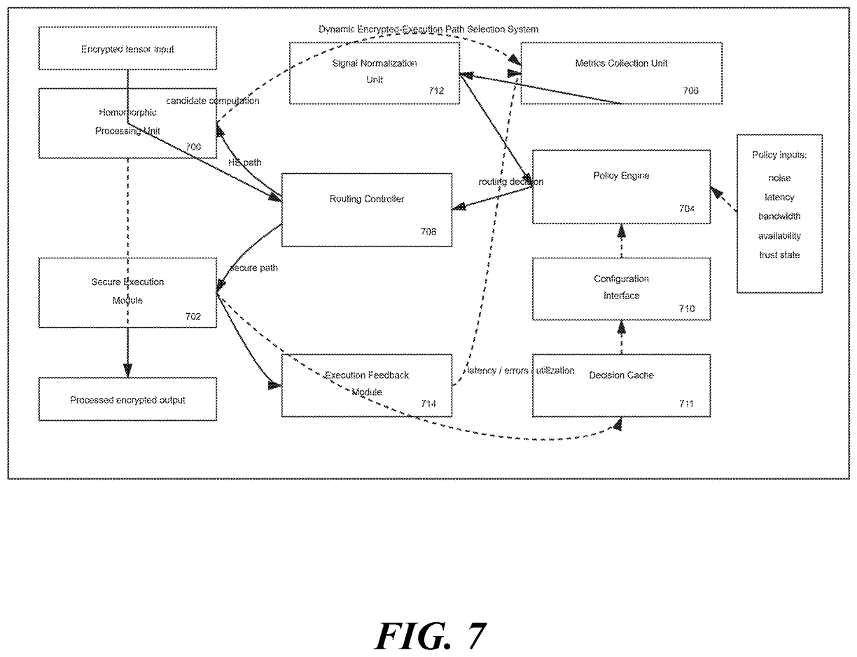

Referring to FIG. 7, a policy-driven execution system is implemented comprising a homomorphic processing unit 700, a secure execution module 702, a policy engine 704, a metrics collection unit 706, a routing controller 708, a configuration interface 710, a decision cache 711, a signal normalization unit 712, and an execution feedback module 714. These components collectively form a closed-loop decision system that dynamically selects the optimal processing pathway for encrypted tensors.

During operation, encrypted semantic tensors generated by upstream components are supplied to the homomorphic processing unit 700, which performs encrypted computations such as aggregation or transformation using a homomorphic-encryption scheme. In parallel, the metrics collection unit 706 monitors a set of system-level parameters, including ciphertext noise levels, processing latency, network bandwidth utilization, node availability, error rates, and trust indicators associated with execution environments.

The metrics collected by the metrics collection unit 706 are passed to the signal normalization unit 712, which standardizes the metrics into a consistent format suitable for policy evaluation. This normalization may involve scaling values to a common range, filtering noise from measurements, or aggregating multiple signals into composite indicators.

The normalized metrics are provided to the policy engine 704, which evaluates the current system state against a set of predefined or dynamically updated policies stored in the configuration interface 710. These policies may specify conditions under which certain execution pathways are preferred, such as prioritizing homomorphic processing when network bandwidth is constrained or invoking secure execution when ciphertext noise or trust risk exceeds acceptable thresholds.

The policy engine 704 generates a routing decision based on the evaluated policies and current system metrics. This decision may be cached in the decision cache 711 to reduce computation overhead for repeated or similar conditions. The routing decision is transmitted to the routing controller 708, which enforces the selected execution pathway.

The routing controller 708 directs encrypted tensors either to continue through the homomorphic processing unit 700 or to be routed to the secure execution module 702, which comprises a trusted execution environment. The secure execution module 702 performs decryption, processing, and re-encryption of tensors within a protected hardware environment, ensuring confidentiality and integrity of sensitive data.

The execution feedback module 714 monitors the outcome of the selected processing pathway, collecting performance metrics such as processing time, error rates, and resource utilization. This feedback is returned to the metrics collection unit 706, forming a feedback loop that allows the system to adapt its behavior over time. The policy engine 704 may update its decision logic based on this feedback, enabling adaptive optimization of execution pathways.

The interaction among the policy engine 704, the metrics collection unit 706, the routing controller 708, and the execution feedback module 714 forms a dynamic control system that continuously evaluates and adjusts processing decisions. This system ensures that encrypted computation is performed efficiently while maintaining security and reliability across varying conditions.

The embodiment may be implemented using a combination of hardware and software components. The homomorphic processing unit 700 may be realized using FPGA or ASIC-based cryptographic accelerators, while the secure execution module 702 may utilize hardware enclave technologies such as Intel SGX, AMD SEV-SNP, or Arm Confidential Compute Architecture. The policy engine 704 may be implemented as a software module running on a CPU or as a hardware-based rule engine, depending on performance requirements.

The metrics collection unit 706 may utilize hardware counters, network monitoring tools, and system telemetry interfaces to gather real-time data. The signal normalization unit 712 and decision cache 711 may be implemented in software or hardware, while the routing controller 708 may be implemented as a programmable logic unit or hardware multiplexer.

The configuration interface 710 may provide an interface for system administrators or automated processes to define and update policies, which may be stored in non-volatile memory or dynamically loaded at runtime. The execution feedback module 714 may utilize logging and monitoring frameworks to collect and analyze performance data.

This embodiment demonstrates that by incorporating a policy-driven control layer into the encrypted computation pipeline, the system can adaptively optimize execution pathways in response to changing conditions. The architecture enhances robustness, efficiency, and flexibility, enabling deployment in diverse environments while maintaining strong privacy guarantees and computational integrity.

### Embodiment 8: Hybrid Cryptographic Aggregation Engine With Dual-Mode Operation

This embodiment demonstrates an aggregation architecture that integrates multiple cryptographic computation paradigms within a unified execution framework, enabling dynamic selection between homomorphic encryption and multi-party computation (MPC) techniques. The embodiment illustrates how a system can balance computational efficiency, fault tolerance, and privacy guarantees by leveraging complementary strengths of different cryptographic methods. By supporting dual-mode aggregation, the system maintains operational continuity under varying network and participation conditions while preserving confidentiality of semantic tensors.

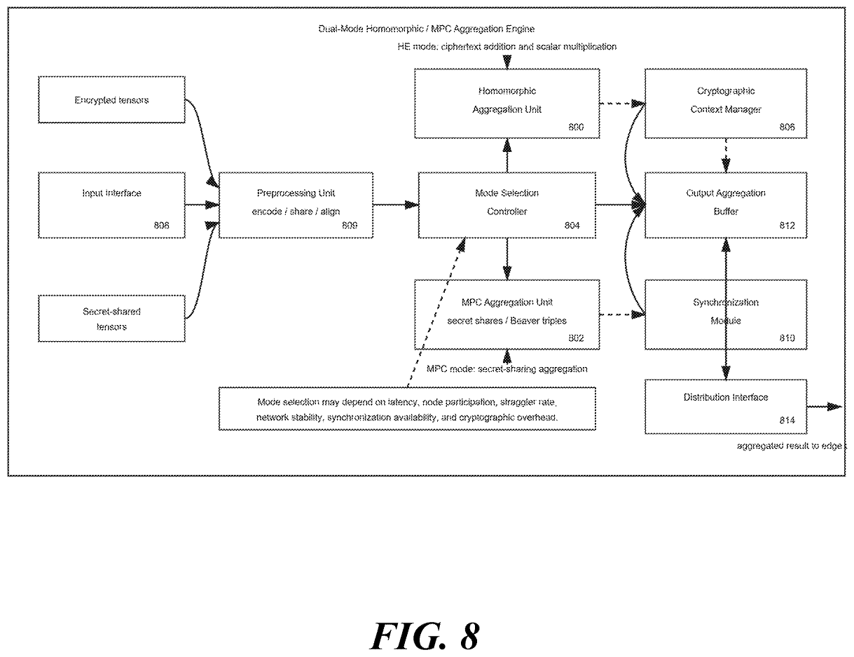

Referring to FIG. 8, a hybrid aggregation engine is implemented comprising a homomorphic aggregation unit 800, a multi-party computation (MPC) aggregation unit 802, a mode selection controller 804, a cryptographic context manager 806, an input interface 808, a preprocessing unit 809, a synchronization module 810, an output aggregation buffer 812, and a distribution interface 814. These components collectively enable coordinated operation of multiple cryptographic aggregation pathways within a single system.

During operation, encrypted or secret-shared semantic tensors are received from edge devices through the input interface 808. These tensors are temporarily stored and formatted by the preprocessing unit 809, which prepares them for processing under either homomorphic encryption or MPC protocols. The preprocessing unit 809 may perform operations such as encoding, share partitioning, or alignment of tensor dimensions.

The mode selection controller 804 determines whether the aggregation should be performed using the homomorphic aggregation unit 800 or the MPC aggregation unit 802. This decision is based on system conditions such as network latency, number of participating nodes, availability of synchronization, and cryptographic overhead. The mode selection controller 804 may receive input from external control systems or internal metrics, enabling adaptive switching between aggregation modes.

When homomorphic aggregation is selected, the homomorphic aggregation unit 800 performs ciphertext-space addition and scaling operations on encrypted tensors. These operations are carried out without decryption, preserving confidentiality while enabling efficient aggregation. The homomorphic aggregation unit 800 may be implemented using hardware-accelerated modular arithmetic circuits or optimized software libraries.

When MPC aggregation is selected, the MPC aggregation unit 802 processes secret-shared tensors using protocols such as additive secret sharing and Beaver triples. In this mode, each tensor is partitioned into multiple shares distributed across cooperating nodes or servers. The MPC aggregation unit 802 performs computations on these shares without reconstructing the underlying plaintext, ensuring that no single entity has access to the complete data.

The cryptographic context manager 806 maintains the cryptographic parameters and keys required for both homomorphic and MPC operations. This includes encryption keys, secret-sharing parameters, and protocol-specific randomness. The cryptographic context manager 806 ensures that transitions between modes are seamless and that appropriate keys and parameters are applied for each aggregation round.

The synchronization module 810 coordinates participation among nodes, particularly for MPC operations that require synchronized interaction among multiple parties. The synchronization module 810 ensures that all required shares are available before computation proceeds and may implement timeout or fallback mechanisms when nodes are unavailable.

Results from either aggregation pathway are stored in the output aggregation buffer 812, which holds the aggregated tensor in encrypted or share-reconstructed form. The distribution interface 814 transmits the aggregated result back to participating edge devices, where it may be decrypted or reconstructed and used for model updates.

The interaction among the mode selection controller 804, the homomorphic aggregation unit 800, and the MPC aggregation unit 802 enables the system to dynamically select the most appropriate aggregation method for current conditions. For example, when network conditions are stable and participation is consistent, MPC may be preferred for its efficiency. When nodes are unreliable or asynchronous, homomorphic aggregation may be used to tolerate missing inputs.

The embodiment may be implemented using a combination of hardware and software resources. The homomorphic aggregation unit 800 may be realized using FPGA or ASIC-based cryptographic accelerators, while the MPC aggregation unit 802 may be implemented using distributed computing frameworks that support secure multi-party protocols. The mode selection controller 804 may be implemented as a software policy engine or hardware control unit, and the cryptographic context manager 806 may utilize secure key storage mechanisms such as hardware security modules.

The input interface 808 and distribution interface 814 may utilize secure communication protocols such as TLS, while the preprocessing unit 809 and synchronization module 810 may be implemented in software running on server CPUs. The output aggregation buffer 812 may reside in high-speed memory to support efficient data transfer.

This embodiment demonstrates that by integrating multiple cryptographic aggregation techniques within a unified architecture, the system can adapt to diverse operational conditions while maintaining strong privacy guarantees. The hybrid approach enhances robustness and flexibility, ensuring that aggregation can proceed efficiently even in the presence of network variability or partial participation.

### Embodiment 9: Hierarchical Aggregation Hardware Architecture for Scalable Federated Learning

This embodiment demonstrates a multi-tier aggregation architecture designed to scale privacy-preserving federated learning across geographically distributed environments while minimizing communication overhead and improving fault tolerance. The embodiment illustrates how encrypted semantic tensors can be aggregated in a hierarchical manner, allowing intermediate aggregation stages to reduce network load and improve system efficiency without compromising confidentiality. The architecture supports large-scale deployments in which edge devices, regional aggregators, and centralized coordination systems operate collaboratively.

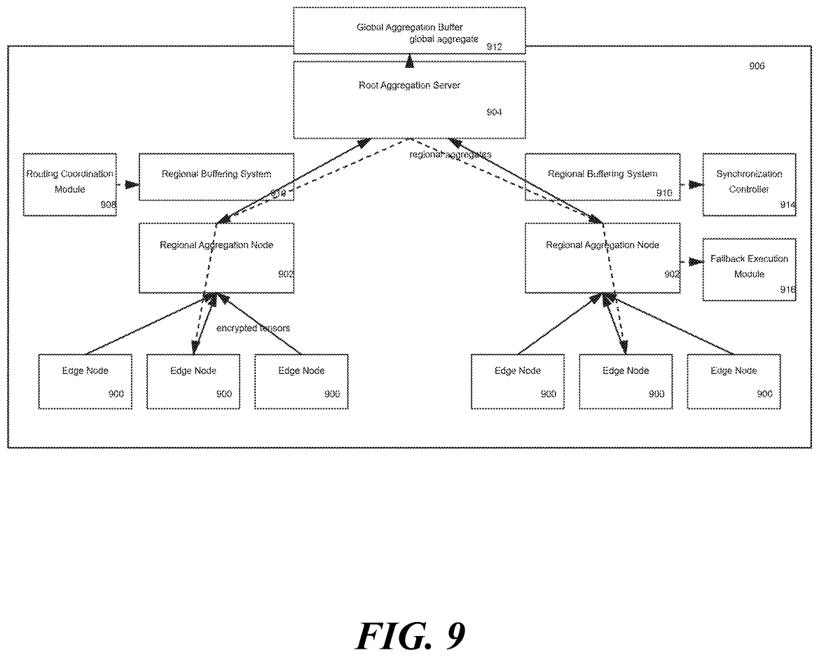

Referring to FIG. 9, a hierarchical aggregation system is implemented comprising a plurality of edge nodes 900, a set of regional aggregation nodes 902, a root aggregation server 904, a network fabric 906, a routing coordination module 908, a regional buffering system 910, a global aggregation buffer 912, a synchronization controller 914, and a fallback execution module 916. These components collectively form a layered aggregation structure that distributes computation across multiple levels of the system.

During operation, each edge node 900 generates a semantic tensor, such as a routing-coefficient tensor or other intermediate representation, using local model execution. The tensor is encrypted at the edge node 900 using a homomorphic-encryption scheme and transmitted through the network fabric 906 to an assigned regional aggregation node 902. The assignment of edge nodes to regional aggregation nodes 902 may be based on geographic proximity, network topology, or administrative grouping.

Each regional aggregation node 902 receives encrypted tensors from its associated edge nodes 900 and stores them in the regional buffering system 910. The regional aggregation node 902 performs homomorphic aggregation operations on the received tensors, such as ciphertext addition and scaling, to produce a regional aggregate tensor. This regional aggregation reduces the volume of data that must be transmitted to higher levels of the system.

The regional aggregate tensor is transmitted from each regional aggregation node 902 to the root aggregation server 904, where it is stored in the global aggregation buffer 912. The root aggregation server 904 performs a second level of aggregation, combining regional aggregates to produce a global aggregate tensor that represents the combined information from all participating edge nodes 900.

The routing coordination module 908 manages the flow of data across the hierarchical structure, ensuring that tensors are correctly routed between edge nodes 900, regional aggregation nodes 902, and the root aggregation server 904. The routing coordination module 908 may also maintain metadata describing the aggregation hierarchy, including node assignments and aggregation weights.

The synchronization controller 914 ensures that aggregation operations are performed in a coordinated manner across different levels of the hierarchy. This controller may enforce synchronization barriers, manage aggregation rounds, and handle cases where certain nodes fail to provide updates within a specified time window. The synchronization controller 914 may also support asynchronous operation modes in which partial aggregates are computed based on available inputs.

The fallback execution module 916 provides a mechanism for handling exceptional conditions, such as excessive ciphertext noise or node failure. When such conditions are detected, the fallback execution module 916 may redirect aggregation tasks to a secure execution environment or adjust aggregation parameters to maintain system stability. This module may operate in conjunction with noise-monitoring systems described in other embodiments.

Once the global aggregate tensor is computed at the root aggregation server 904, it is transmitted back through the hierarchy to the regional aggregation nodes 902, which forward the tensor to the edge nodes 900. Each edge node 900 decrypts the received tensor and incorporates it into local model updates, thereby aligning local models with the global representation.

The interaction among the edge nodes 900, regional aggregation nodes 902, and the root aggregation server 904 forms a scalable aggregation pipeline in which data is progressively combined at multiple levels. The regional buffering system 910 and global aggregation buffer 912 support efficient storage and retrieval of encrypted tensors, while the routing coordination module 908 and synchronization controller 914 ensure consistent operation across the system.

The embodiment may be implemented using commodity hardware for the edge nodes 900, such as GPU-equipped devices, and server-class hardware for the regional aggregation nodes 902 and root aggregation server 904. The network fabric 906 may include local-area networks, wide-area networks, or cloud-based communication infrastructure. The aggregation operations may be accelerated using hardware or software implementations of homomorphic encryption.

The regional aggregation nodes 902 may be deployed in data centers or edge computing facilities, reducing latency and bandwidth usage by performing aggregation closer to data sources. The root aggregation server 904 may be hosted in a centralized cloud environment with sufficient computational resources to handle global aggregation tasks.

This embodiment demonstrates that by distributing aggregation across multiple hierarchical levels, the system achieves improved scalability, reduced network load, and enhanced resilience to node failures. The architecture maintains privacy by ensuring that all intermediate and final aggregation steps are performed on encrypted data, while enabling efficient coordination of large-scale federated learning systems.

### Embodiment 10: Integrated AI and Cryptographic System-on-Chip (SoC) for Privacy-Preserving Federated Learning

This This embodiment demonstrates a fully integrated hardware platform that combines machine-learning acceleration, cryptographic processing, and secure execution capabilities within a single semiconductor device. The embodiment illustrates how privacy-preserving semantic aggregation can be implemented as a tightly coupled, low-latency system suitable for edge deployments, where constraints on power, bandwidth, and physical footprint are significant. By integrating all major functional components on a single die, the system achieves improved performance, reduced energy consumption, and enhanced security through minimized data movement.

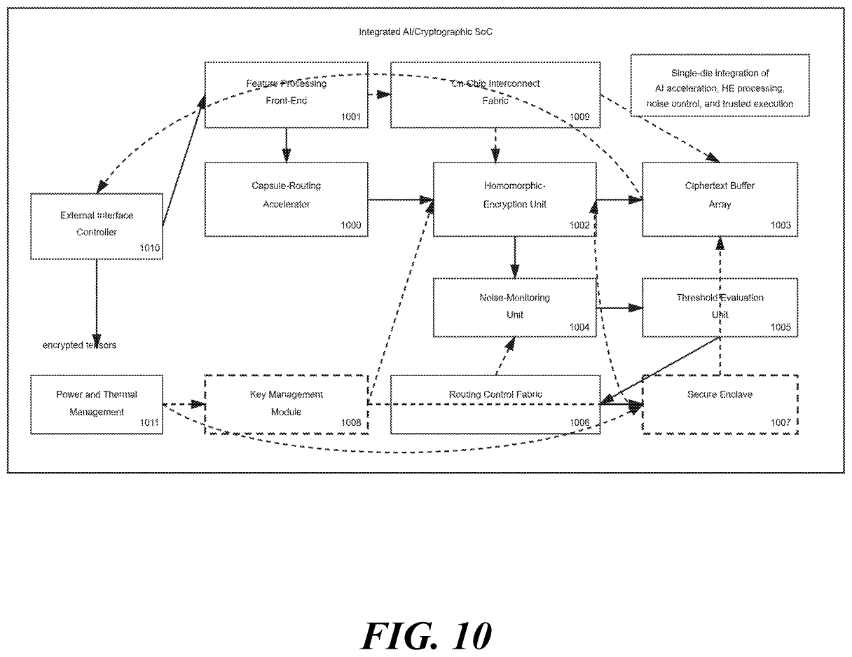

Referring to FIG. 10, an integrated system-on-chip is implemented comprising a capsule-routing accelerator 1000, a feature processing front-end 1001, a homomorphic-encryption unit 1002, a ciphertext buffer array 1003, a noise-monitoring unit 1004, a threshold evaluation unit 1005, a routing control fabric 1006, a secure enclave 1007, a key management module 1008, an on-chip interconnect fabric 1009, an external interface controller 1010, and a power and thermal management subsystem 1011. These components are fabricated on a single semiconductor die and interconnected through the on-chip interconnect fabric 1009.

During operation, input data is received through the external interface controller 1010, which may support high-speed communication protocols such as PCIe, Ethernet, or dedicated accelerator interfaces. The data is passed to the feature processing front-end 1001, which performs initial transformations such as convolution, embedding, or projection to generate feature representations suitable for capsule-based processing.

The processed features are supplied to the capsule-routing accelerator 1000, which executes routing-by-agreement operations to generate a routing-coefficient tensor representing semantic relationships within the data. The capsule-routing accelerator 1000 may utilize parallel tensor cores, matrix multiplication units, and reduced-precision arithmetic to achieve high throughput while maintaining acceptable accuracy.

The routing-coefficient tensor is passed through the on-chip interconnect fabric 1009 to the homomorphic-encryption unit 1002, which quantizes and encrypts the tensor using a leveled homomorphic-encryption scheme. The encrypted tensor is stored in the ciphertext buffer array 1003, which provides temporary storage and supports pipelined processing of multiple tensors.

The noise-monitoring unit 1004 tracks the accumulation of ciphertext noise associated with operations performed by the homomorphic-encryption unit 1002. Metrics such as modulus-switching depth and noise variance are evaluated and supplied to the threshold evaluation unit 1005, which determines whether the noise level exceeds a predefined threshold.

The threshold evaluation unit 1005 communicates with the routing control fabric 1006, which governs the flow of encrypted tensors within the chip. When noise levels remain within acceptable limits, the routing control fabric 1006 directs tensors to continue through the homomorphic-encryption unit 1002 for further processing. When noise levels exceed the threshold, the routing control fabric 1006 redirects tensors to the secure enclave 1007.

The secure enclave 1007 is implemented as a hardware-isolated execution environment within the SoC, providing protected memory and execution resources. Within the secure enclave 1007, encrypted tensors are decrypted using keys managed by the key management module 1008, aggregated in plaintext, and re-encrypted using refreshed cryptographic parameters. The resulting ciphertext is returned to the ciphertext buffer array 1003 for further processing or transmission.

The key management module 1008 securely stores and manages cryptographic keys used by both the homomorphic-encryption unit 1002 and the secure enclave 1007. The module may include hardware security features such as tamper resistance, secure key generation, and access control mechanisms to prevent unauthorized access.

The on-chip interconnect fabric 1009 provides high-bandwidth, low-latency communication among all components of the SoC. It may be implemented using a network-on-chip (NoC) architecture that supports parallel data transfers and prioritization of critical data paths.

The external interface controller 1010 transmits encrypted tensors to external aggregation systems and receives aggregated tensors from other devices. This interface enables the SoC to participate as an edge node in a federated learning system, exchanging only encrypted semantic tensors.

The power and thermal management subsystem 1011 monitors and regulates power consumption and heat dissipation across the SoC. This subsystem may dynamically adjust operating parameters, such as clock frequency and voltage, to maintain optimal performance while preventing thermal overload.

The interaction among the capsule-routing accelerator 1000, the homomorphic-encryption unit 1002, the noise-monitoring unit 1004, and the secure enclave 1007 forms a tightly integrated pipeline in which semantic tensors are generated, protected, monitored, and conditionally processed within a single device. The routing control fabric 1006 ensures that data flows efficiently between components while adapting to changing cryptographic conditions.

The embodiment may be fabricated using advanced semiconductor processes, such as 5 nm or 7 nm CMOS technology, enabling high transistor density and energy efficiency. The capsule-routing accelerator 1000 may incorporate GPU-like tensor cores, while the homomorphic-encryption unit 1002 may include dedicated modular arithmetic units optimized for polynomial operations. The secure enclave 1007 may leverage hardware isolation techniques similar to those used in trusted execution environments.

This embodiment demonstrates that by integrating machine-learning and cryptographic processing within a single system-on-chip, the system achieves a compact, high-performance solution for privacy-preserving federated learning. The architecture minimizes data movement, reduces latency, and enhances security by confining sensitive operations within a single protected hardware environment, making it particularly suitable for deployment in edge devices and resource-constrained environments.

Various additions, modifications or substitutions may be made to the systems, devices and methodologies disclosed herein without departing from the scope of the present disclosure. Some of these are described below.

In preferred embodiments of the systems, devices and methodologies disclosed herein, the model execution process further incorporates a retrieval-augmented latent fusion mechanism in which intermediate latent representations are combined with stored reference latents selected from a local or distributed repository. A plurality of latent vectors, referred to as anchor latents, are maintained in a storage structure and represent previously observed or synthesized semantic patterns. During execution of a generative or discriminative model, a query latent derived from current input data is compared against the anchor latents using a similarity metric, and one or more anchor latents are selected based on the similarity results.

The selected anchor latents are combined with the query latent to produce a fused latent tensor that is supplied to downstream model components. The fusion process may include weighted averaging, attention-based combination, or other blending operations in which similarity scores determine contribution weights. The fused latent tensor serves as an input to a capsule-based network or generative model, enabling incorporation of prior semantic knowledge into current processing. This mechanism enhances representation quality while maintaining locality of raw data, as only latent representations are accessed and combined.

In preferred embodiments, anchor latents are maintained in a bounded-capacity reservoir that stores a plurality of representative latent vectors. The reservoir may be implemented as a fixed-size memory structure in which newly generated or accepted latent vectors are inserted based on evaluation criteria, such as novelty, similarity distribution, or external validation signals. When the reservoir reaches capacity, one or more existing latent vectors may be removed according to an eviction policy, which may include least-recently-used, least-novel, or similarity-based criteria.

The reservoir may be indexed using a similarity structure that enables efficient retrieval of anchor latents corresponding to a given query latent. In some embodiments, the reservoir is implemented using a k-centroid structure in which stored vectors represent cluster centers within a latent space. The reservoir may be updated periodically based on aggregated semantic statistics, enabling adaptation to evolving data distributions without requiring exchange of raw data among devices.

In preferred embodiments, the model execution engine comprises a generative-adversarial network in which a generator module produces candidate outputs from latent representations and a discriminator module evaluates the outputs to guide training. The generator may receive a fused latent tensor comprising both stochastic input and retrieved anchor latents, while the discriminator evaluates generated outputs using loss functions that may include hinge loss, spectral normalization, or other regularization techniques.

The capsule-based routing mechanism operates within or alongside the generative-adversarial structure, producing routing-coefficient tensors that encode relationships among semantic entities represented within the latent space. These routing-coefficient tensors are extracted and processed according to the encrypted aggregation techniques described herein. By integrating capsule routing with generative-adversarial processing, the system produces structured semantic representations that are suitable for aggregation while maintaining model expressiveness.

In preferred embodiments, the disclosed systems are deployed in environments in which data is subject to regulatory constraints, such as healthcare, finance, or industrial systems. Each participating node may operate within an institutional boundary and access locally stored data through secure interfaces. For example, a node may interface with a medical imaging system to retrieve diagnostic data, process the data using a local model, and generate semantic tensors for aggregation without transmitting the underlying data outside the institution.

The aggregation process enables multiple institutions to collaboratively train or refine a shared model while maintaining compliance with data sovereignty requirements. Intermediate semantic representations are exchanged in encrypted form, and no raw data or directly identifying information is transmitted between nodes. This deployment model enables cross-institutional learning while preserving confidentiality and regulatory compliance.

Various additional embodiments may employ alternative forms of semantic tensor generation in which the extracted representation is derived from combinations of multiple layers of a machine-learning model rather than a single intermediate layer. In such implementations, semantic tensors may be formed by concatenation, projection, or aggregation of multiple intermediate representations, including but not limited to cross-layer attention patterns, residual feature streams, or hybrid embedding structures. The selection and combination of such representations may be dynamically configured based on task requirements, model architecture, or privacy considerations, thereby enabling adaptive extraction of semantically meaningful information without exposing raw input data.

In certain embodiments, the transformation of semantic tensors into representations suitable for encrypted computation may include additional preprocessing operations beyond quantization. These operations may include normalization, clipping, dimensionality reduction, or structured encoding techniques designed to improve compatibility with cryptographic processing constraints. For example, semantic tensors may be projected into lower-dimensional subspaces or encoded using structured bases to reduce computational complexity and communication overhead while preserving essential semantic information. Such transformations may be implemented in software, hardware, or a combination thereof.

In some implementations, the cryptographic processing pipeline may incorporate alternative or supplemental encryption schemes in addition to or in place of homomorphic encryption. For example, partially homomorphic encryption, secure multi-party computation protocols, or hybrid cryptographic techniques may be employed to perform aggregation operations while maintaining confidentiality. The system may dynamically select among these approaches based on performance metrics, security requirements, or network conditions, thereby enabling flexible deployment across diverse computational environments.

In further embodiments, aggregation operations may be extended beyond simple averaging or summation to include weighted aggregation, clustering, or consensus-based methods. For example, semantic tensors received from different edge nodes may be assigned weights based on data quality, node reliability, or statistical significance, and the aggregation process may incorporate these weights to produce a more representative global tensor. Alternatively, clustering techniques may be applied to group similar semantic tensors prior to aggregation, enabling more granular representation of distributed data characteristics.

In certain embodiments, the aggregation server may be replaced or supplemented by a decentralized or peer-to-peer aggregation architecture in which edge nodes exchange encrypted semantic tensors directly with one another. In such configurations, aggregation may be performed collaboratively among subsets of nodes without reliance on a centralized server, thereby improving fault tolerance and reducing single points of failure. Consensus protocols or distributed coordination mechanisms may be used to ensure consistency of aggregated results across participating nodes.

In some implementations, the decryption and model update process at each edge node may incorporate additional processing steps that utilize the aggregated semantic tensor in multiple ways. For example, the aggregated tensor may be used not only to update model parameters directly, but also to regularize intermediate representations, guide feature alignment, or influence auxiliary loss functions. In certain embodiments, the aggregated tensor may be combined with locally generated tensors using blending or interpolation techniques, enabling gradual integration of global information into local models.

In further embodiments, communication between edge nodes and aggregation systems may be optimized through adaptive transmission strategies. For example, semantic tensors may be transmitted at variable frequencies depending on system conditions, model convergence rates, or network availability. In some cases, edge nodes may selectively transmit only portions of a semantic tensor, such as high-magnitude components or regions of interest, while omitting less informative elements. Such selective transmission may be combined with compression or encoding techniques to further reduce bandwidth requirements.

In certain implementations, the system may incorporate additional security mechanisms to enhance protection of encrypted data during transmission and processing. These mechanisms may include authenticated encryption, integrity verification, secure key exchange protocols, or attestation procedures that verify the integrity of participating devices or execution environments. In some embodiments, cryptographic operations may be combined with hardware-based security features, such as trusted execution environments or hardware security modules, to provide layered protection against unauthorized access or tampering.

In some embodiments, the system may support adaptive model architectures in which the structure of the machine-learning model evolves over time based on aggregated semantic information. For example, model components may be reconfigured, expanded, or pruned in response to patterns observed in aggregated semantic tensors, enabling the system to adapt to changing data distributions or emerging features. Such adaptive behavior may be coordinated across edge nodes using the aggregated tensors as a shared reference for model evolution.

In further embodiments, the disclosed methodologies may be applied to a wide range of application domains beyond those explicitly described. For example, the techniques may be used in natural language processing, computer vision, speech recognition, industrial monitoring, financial modeling, or any other domain in which distributed learning and data privacy are important considerations. The specific form of the semantic tensor and the associated model architecture may vary depending on the application, while the core principles of encrypted semantic aggregation and distributed model update remain applicable.

In some embodiments, the systems and methodologies disclosed herein may be implemented in a service-oriented or platform-based architecture in which one or more components are exposed via application programming interfaces (APIs) or cloud-based services. For example, the aggregation functionality may be provided as a managed service accessible by a plurality of edge nodes, and edge nodes may be provisioned with client-side software configured to interface with the service. In such embodiments, control over execution of the federated training process may be exercised by a centralized orchestration system, enabling coordinated operation across independently managed devices while maintaining privacy-preserving properties.

In certain embodiments, the disclosed techniques may be applied not only during model training but also during inference, evaluation, or hybrid training-inference workflows. For example, semantic tensors generated during inference may be aggregated across devices to refine model behavior, detect distributional drift, or improve calibration of model outputs. In other embodiments, aggregated semantic tensors may be used to derive global statistics or constraints that influence inference-time decision making, thereby extending the benefits of distributed semantic aggregation beyond training phases.

In some implementations, the machine-learning model may comprise or interact with large-scale models, including transformer-based architectures, generative models, or multi-agent systems. Semantic tensors may be derived from components such as attention mechanisms, token embeddings, hidden-state representations, or inter-agent communication structures. The aggregation of such tensors enables alignment of internal representations across distributed models, facilitating coordinated behavior or shared semantic understanding without requiring exchange of raw data or full model parameters.

In further embodiments, the systems and methodologies disclosed herein may incorporate governance and policy enforcement mechanisms that regulate how semantic tensors are generated, transmitted, aggregated, and applied. Such mechanisms may include access controls, usage policies, audit logging, or compliance rules that ensure adherence to organizational or regulatory requirements. For example, policies may restrict aggregation of certain categories of semantic tensors, enforce limits on transmission frequency, or require verification of aggregation results prior to use in model updates.

In certain embodiments, semantic tensors may be associated with metadata that describes properties of the underlying data or model state without revealing sensitive information. Such metadata may include statistical summaries, confidence measures, provenance indicators, or temporal information. The metadata may be processed alongside the semantic tensors, either in encrypted or unencrypted form, to inform aggregation decisions, weighting strategies, or model updates. This approach enables richer coordination among distributed nodes while preserving confidentiality of underlying data.

In some implementations, the system may support heterogeneous edge nodes having differing computational capabilities, model architectures, or data modalities. Semantic tensors generated by such nodes may vary in dimensionality, structure, or representation. In such cases, compatibility mechanisms may be employed to align or transform semantic tensors into a common aggregation space. These mechanisms may include learned projection layers, normalization processes, or adaptive mapping functions that enable meaningful aggregation across diverse node configurations.

In further embodiments, aggregation operations may be combined with validation or verification mechanisms to ensure correctness and integrity of results. For example, the aggregation server or participating nodes may generate verification data, such as cryptographic proofs, checksums, or consistency indicators, that can be used to confirm that aggregation operations were performed as intended. Such mechanisms may be used in conjunction with secure execution environments or external verification systems to provide additional assurance in high-trust or regulated environments.

In certain embodiments, the systems and methodologies disclosed herein may be configured to operate under varying levels of trust among participating entities. For example, some deployments may assume a trusted aggregation server, while others may assume that all parties are mutually untrusted. The system may adapt its processing strategies accordingly, for example by increasing reliance on encryption, secure multi-party computation, or verification mechanisms in lower-trust environments. This flexibility enables deployment across a wide range of operational contexts with differing security assumptions.

In some embodiments, the semantic tensor may be partitioned, segmented, or otherwise decomposed into multiple sub-tensors prior to encryption and transmission. Each sub-tensor may represent a portion of the overall semantic structure, such as a subset of features, spatial regions, or token groups. The sub-tensors may be processed independently or in parallel and later recombined, either at the aggregation server or at the edge nodes, to reconstruct an aggregated semantic representation. This approach enables finer-grained control over computation, communication, and privacy, and may be used to adapt system behavior to resource constraints or application-specific requirements.

In certain embodiments, the semantic tensor may be generated using stochastic or probabilistic mechanisms, including sampling-based representations, variational encodings, or noise-augmented latent variables. In such cases, the aggregation of semantic tensors may incorporate statistical operations that preserve or exploit probabilistic structure, such as expectation estimation, variance reduction, or distribution alignment. This enables the system to aggregate not only deterministic representations but also probabilistic semantic information across distributed nodes.

In further embodiments, the aggregation process may incorporate temporal or sequential information associated with semantic tensors. For example, semantic tensors generated at different time steps or across sequential inputs may be aggregated in a manner that preserves temporal relationships or trends. Such aggregation may be used to support time-series analysis, streaming data processing, or adaptive learning in dynamic environments. Temporal aggregation may be performed using sliding windows, decay functions, or sequence-aware operations.

In some implementations, the system may support cross-model or cross-task aggregation in which semantic tensors generated by different models or for different tasks are aggregated within a shared framework. For example, semantic tensors derived from models trained on related but distinct tasks may be combined to produce a unified representation that captures shared structure. This enables transfer learning, multi-task learning, or domain adaptation across distributed environments without requiring direct sharing of model parameters or training data.

In certain embodiments, semantic tensors may be associated with confidence measures, uncertainty estimates, or quality indicators that influence aggregation behavior. For example, tensors generated from higher-confidence predictions or higher-quality data may be weighted more heavily during aggregation. Such weighting may be performed in encrypted form or applied after decryption at the edge nodes. This approach improves robustness by reducing the impact of noisy or unreliable contributions.

In further embodiments, the system may incorporate mechanisms for detecting and mitigating anomalous or adversarial inputs at the level of semantic tensors. For example, statistical analysis, outlier detection, or consistency checks may be applied to semantic tensors prior to or after aggregation to identify contributions that deviate significantly from expected patterns. Such mechanisms may be used to exclude, down-weight, or flag anomalous tensors, thereby improving system resilience in adversarial or unreliable environments.

In some embodiments, semantic tensors may be selectively masked or redacted prior to encryption to prevent disclosure of sensitive subcomponents. For example, portions of a tensor corresponding to protected features, rare conditions, or identifying patterns may be removed or replaced with neutral values before transmission. The masking process may be governed by policies, learned models, or external constraints, and may be reversible or irreversible depending on system requirements.

In certain implementations, the system may support incremental or partial model updates in which only a subset of model parameters is updated based on the aggregated semantic tensor. For example, the aggregated tensor may be used to update only specific layers, modules, or parameter groups within the model. This enables targeted learning, reduces computational overhead, and provides additional control over how global information influences local models.

In further embodiments, the system may support integration with external data sources, knowledge bases, or contextual information systems. For example, aggregated semantic tensors may be combined with external signals such as structured databases, ontologies, or rule-based systems to enhance model performance. Such integration may occur at the edge nodes or within controlled environments, and may leverage semantic alignment between learned representations and external knowledge structures.

In some embodiments, the system may include mechanisms for lifecycle management of semantic tensors and associated data. For example, tensors may be retained, archived, expired, or deleted according to retention policies, storage constraints, or regulatory requirements. Lifecycle management may also include versioning of aggregated tensors, enabling rollback, comparison, or audit of historical states of the system.

In certain embodiments, the disclosed techniques may be applied in conjunction with model personalization or customization at individual edge nodes. For example, each node may maintain a personalized model that is influenced by both local data and aggregated semantic tensors, allowing adaptation to local conditions while benefiting from global information. The degree of personalization may be controlled through weighting, gating, or selective application of aggregated tensors.

In further embodiments, the system may support continuous or online learning in which semantic tensors are generated, aggregated, and applied in near real-time. This enables rapid adaptation to changing data distributions, user behavior, or environmental conditions. Continuous learning may be coordinated using streaming architectures, event-driven processing, or asynchronous update mechanisms.

In some embodiments, the semantic tensor may be associated with versioning information that identifies the state of the model, training round, or aggregation context from which the tensor was generated. Such versioning information may be used to ensure compatibility among tensors generated at different times or by different nodes, and may enable selective application of aggregated tensors based on version alignment. In certain implementations, version mismatches may trigger transformation, rejection, or deferred application of aggregated tensors.

In certain embodiments, the system may support rollback or replay of aggregation states in which previously aggregated semantic tensors are re-applied to a model. For example, stored encrypted or decrypted aggregates may be used to restore a prior model state, evaluate alternative training paths, or perform comparative analysis across training histories. Such capabilities may be useful for debugging, auditing, or optimizing distributed learning processes.

In further embodiments, the aggregation process may be auditable through reconstruction or verification of aggregation inputs and outputs. For example, participating nodes may maintain records of transmitted tensors, received aggregates, and applied updates, and these records may be compared or validated against aggregation results. Verification may be performed using cryptographic techniques, consistency checks, or independent recomputation, enabling detection of discrepancies or unauthorized modifications.

In some implementations, the system may support selective participation of edge nodes in aggregation rounds. For example, nodes may opt in or out of specific rounds based on resource availability, policy constraints, or data conditions. Aggregation operations may proceed using available inputs, and mechanisms may be employed to account for partial participation, such as normalization factors, weighting schemes, or compensation strategies.

In certain embodiments, the semantic tensor may be generated or processed using techniques that enforce structural constraints, such as sparsity, orthogonality, or low-rank structure. These constraints may be imposed to improve efficiency, interpretability, or compatibility with encrypted computation. Aggregation operations may preserve or exploit such structure, enabling more efficient processing and more stable model updates.

In further embodiments, the system may include mechanisms for interoperability with external systems or protocols. For example, semantic tensors or aggregated results may be exported to or imported from external machine-learning pipelines, analytics systems, or orchestration frameworks. Such interoperability may be achieved through standardized data formats, communication protocols, or interface definitions, enabling integration into broader computational ecosystems.

In some embodiments, the disclosed techniques may be applied in environments involving regulatory or contractual constraints on data usage, including but not limited to privacy regulations, data residency requirements, or usage agreements. The system may enforce such constraints through configuration, policy enforcement, or architectural design, ensuring that semantic tensor generation, transmission, and aggregation comply with applicable requirements.

In certain implementations, the system may support monitoring and optimization of resource utilization across edge nodes and aggregation infrastructure. For example, metrics related to computation, memory, network bandwidth, or energy consumption may be collected and used to adjust system behavior. Such adjustments may include modifying aggregation frequency, selecting processing pathways, or tuning model parameters to achieve desired performance objectives.

In further embodiments, the system may incorporate mechanisms for resilience and fault recovery in the presence of failures or disruptions. For example, aggregation operations may be retried, recomputed, or bypassed in response to failures, and edge nodes may recover from missed updates by synchronizing with subsequent aggregates. Such mechanisms may ensure continuity of operation and robustness in distributed environments.

The above description of the present invention is illustrative and is not intended to be limiting. It will thus be appreciated that various additions, substitutions and modifications may be made to the above described embodiments without departing from the scope of the present invention. Accordingly, the scope of the present invention should be construed in reference to the appended claims. It will also be appreciated that the various features set forth in the claims may be presented in various combinations and sub-combinations in future claims without departing from the scope of the invention. In particular, the present disclosure expressly contemplates any such combination or sub-combination that is not known to the prior art, as if such combinations or sub-combinations were expressly written out.

What is claimed is:

1. A computer-implemented method for privacy-preserving federated training of a machine-learning model, the method being performed by a plurality of edge nodes and at least one aggregation server, each edge node comprising one or more processors, the method comprising:
at each edge node, executing, using the one or more processors, a machine-learning model to generate, for a training step, a semantic tensor representing relationships or associations among features or representations within the model;
transforming the semantic tensor into a numerical representation compatible with encrypted computation and encrypting the transformed tensor under a cryptographic scheme that supports computation on encrypted data;
transmitting the encrypted semantic tensor from each edge node to the aggregation server over a network;
at the aggregation server, without decrypting the encrypted semantic tensors, performing aggregation operations on the encrypted semantic tensors to produce an encrypted aggregate semantic tensor;
transmitting the encrypted aggregate semantic tensor from the aggregation server to the edge nodes;
at each edge node, decrypting the encrypted aggregate semantic tensor using a locally stored cryptographic key or key share and updating parameters of the machine-learning model based on the decrypted aggregate semantic tensor; and
repeating the foregoing steps over a plurality of training rounds.

2. The method of claim 1, wherein the semantic tensor comprises an intermediate representation generated by an internal layer of the machine-learning model.

3. The method of claim 1, wherein the semantic tensor comprises at least one of: an attention matrix, a feature map, an embedding tensor, or a routing-coefficient tensor.

4. The method of claim 1, wherein transforming the semantic tensor comprises quantizing the semantic tensor to a fixed-point representation prior to encryption.

5. The method of claim 1, wherein the cryptographic scheme comprises a homomorphic-encryption scheme supporting at least ciphertext-space addition.

6. The method of claim 5, wherein the homomorphic-encryption scheme further supports plaintext-scalar multiplication.

7. The method of claim 1, wherein the machine-learning model comprises a capsule-based neural network.

8. The method of claim 7, wherein the semantic tensor comprises a routing-coefficient tensor representing assignment probabilities among capsules.

9. The method of claim 1, further comprising injecting noise into the semantic tensor prior to encryption to satisfy a differential-privacy constraint.

10. The method of claim 9, wherein the noise is sampled from a Gaussian or Laplace distribution.

11. The method of claim 1, wherein the aggregation server performs the aggregation operations without access to any decryption key corresponding to the encrypted semantic tensors.

12. The method of claim 1, further comprising monitoring a noise metric associated with the encrypted semantic tensor.

13. The method of claim 12, further comprising, in response to the noise metric exceeding a threshold, routing computation to a secure execution environment.

14. The method of claim 13, wherein the secure execution environment performs decryption, aggregation, and re-encryption of the semantic tensor.

15. The method of claim 1, further comprising sparsifying the semantic tensor prior to encryption by retaining a subset of values based on magnitude.

16. The method of claim 1, further comprising compressing the semantic tensor prior to encryption using an encoding scheme compatible with encrypted computation.

17. The method of claim 1, wherein aggregation is performed hierarchically using one or more intermediate aggregation nodes.

18. The method of claim 1, wherein the aggregation operations are performed asynchronously with respect to at least one edge node.

19. The method of claim 1, wherein the machine-learning model is executed using a hardware accelerator comprising at least one of a graphics processing unit, tensor processing unit, or application-specific integrated circuit.

20. The method of claim 1, wherein encryption or aggregation operations are accelerated using dedicated cryptographic hardware.
